(19) United States
(12) Patent Application Publication
(10) Pub. No.: US 2009/0233063 A1
(43) Pub. Date: Sep. 17, 2009

(54) LIQUID COMPOSITION FOR MAKING PIGMENT FIXED, INK SET, METHOD FOR PRODUCING INK JET RECORDED MATTER ON FABRIC AND INK JET RECORDED MATTER ON FABRIC

(75) Inventors: Masahiro YATAKE, Shiojiri-shi (JP); Yoshimasa TAMURA, Shiojiri-shi (JP)

Correspondence Address: LADAS & PARRY LLP, 26 WEST 61ST STREET, NEW YORK, NY, 10023, US

(73) Assignee: SEIKO EPSON CORPORATION

(21) Appl. No.: 12/398,721

(22) Filed: Mar. 5, 2009

(30) Foreign Application Priority Data
Mar. 6, 2008 (JP) 2008-055902
Mar. 6, 2008 (JP) 2008-055904
Feb. 12, 2009 (JP) 2009-030342

(51) Int. Cl. B32B 3/10; C08F 20/06; B05D 5/06; C08F 271/02; C08L 39/00; C08L 33/02; C08K 3/04; C08K 5/05

(52) U.S. Cl. 428/195.1; 525/324; 427/288; 525/279; 524/548; 524/560; 524/496; 524/379

(57) ABSTRACT

There are provided a liquid composition for making pigment fixed having a high resistance to rubbing and a good dry-cleanability; an ink set including the liquid composition for making pigment fixed and an ink composition excellent in terms of color intensity, discharge stability, and adhesiveness; and a method for producing ink-jet-recorded matter on a fabric having a high resistance to rubbing and good dry-cleanability using the liquid composition for making pigment fixed and the ink composition.

The liquid composition for making pigment fixed according to the present invention contains at least polymer fine particles synthesized using an alkyl (meth)acrylate and/or cyclic alkyl (meth)acrylate and a reactive compound having an ethylene-based unsaturated compound and a reactive group, the glass transition temperature and the acid value of the liquid composition being equal to or lower than −10° C. and equal to or lower than 100 mg KOH/g, respectively.

### CROSS-REFERENCES TO RELATED APPLICATIONS

The entire disclosure of Japanese Patent Application No. 2008-55902, filed on Mar. 6, 2008, No. 2008-55904, filed on Mar. 6, 2008, No. 2009-030342, filed on Feb. 12, 2009, are expressly incorporated by reference herein.

### FIELD OF THE INVENTION

The present invention relates to a liquid composition for making pigment fixed having a high resistance to rubbing and good dry-cleanability; an ink set including the liquid composition for making pigment fixed and an ink composition excellent in terms of color intensity, discharge stability, and adhesiveness; a method for producing ink-jet-recorded matter on a fabric having a high resistance to rubbing and good dry-cleanability using the liquid composition for making pigment fixed and the ink composition; and ink-jet-recorded matter on a fabric produced by the method.

### BACKGROUND OF THE INVENTION

There is demand that ink for ink jet recording should have the following characteristics: in printing on paper, fabrics, or any other recording media, it produces no blurs, dries fast, ensures uniform printing on the surface of a wide variety of recording media, produces no mixing of adjacent colors in polychromic printing, such as color printing, and so forth.

Many of such inks, in particular, those containing a pigment as a colorant, have reduced permeability to recording media as main measures to protect the recording medium from being wet by the ink, thereby retaining droplets thereof near the surface of the recording medium, and thus ensure a sufficient printing quality for actual use. However, such inks, being unlikely to wet recording media, would produce blurs to widely different extents depending on the kind of raw material of recording media. In particular, in printing on recycled paper composed of various paper materials, this poses the problem that blurs occur because of difference in wettability to the ink among the paper materials. Furthermore, prints obtained using such inks dry slowly and thus experience mixing of adjacent colors in polychromic printing, such as color printing (occurrence of color breed). Moreover, prints obtained using a pigment ink retain the pigment on the surface of the recording medium and thus are poor in terms of resistance to rubbing.

As a solution to these problems, inks having an improved permeability to recording media have been looked for. Inks under study include an ink containing diethylene glycol monobutyl ether (see Patent Document 1), an ink containing Surfynol 465 (manufactured by Nissin Chemical Industry Co., Ltd.), an acetylene-glycol-based surfactant (see Patent Document 2), an ink containing both the additives above (see Patent Document 3), and so forth.

As for inks containing a pigment, it is usually difficult to improve the permeability of the ink while maintaining the dispersion stability of the pigment contained in the ink, and thus there are few options of applicable penetrants. Inks containing a combination of a glycol ether and a pigment under study include an ink containing a pigment and triethylene glycol monomethyl ether (see Patent Document 4) and an ink containing a pigment and an ether of ethylene glycol, diethylene glycol, or triethylene glycol (see Patent Document 5).

As for inks for textiles, an ink containing a dye (see Patent Document 6) and an ink containing a binder (see Patent Document 7) are known.

As for padding of prints carrying an image or the like, a padding agent containing a certain compound, a method for padding such prints, and so forth are known (see Patent Documents 8 and 9).

[Patent Document 1] U.S. Pat. No. 5,156,675

[Patent Document 2] U.S. Pat. No. 5,183,502

[Patent Document 3] U.S. Pat. No. 5,196,056

[Patent Document 4] Japanese Unexamined Patent Application Publication No. S56-147861

[Patent Document 5] Japanese Unexamined Patent Application Publication No. H9-111165

[Patent Document 6] Japanese Unexamined Patent Application Publication No. 2007-515561

[Patent Document 7] Japanese Unexamined Patent Application Publication No. 2007-126635

[Patent Document 8] Japanese Unexamined Patent Application Publication No. 2005-281952

[Patent Document 9] Japanese Unexamined Patent Application Publication No. 2004-149934

### SUMMARY OF THE INVENTION

### Problems to be Solved by the Invention

However, known padding agents have insufficient resistance to rubbing and dry-cleanability. Furthermore, there are no studies aiming at the production of ink-jet-recorded matter on a fabric having a high resistance to rubbing and a good dry-cleanability and looking for an ink composition for ink jet recording excellent in terms of color intensity, discharge stability, and adhesiveness and a liquid composition for making pigment fixed ideal for the use with such an ink composition. Also, there are no studies on a method for producing ink-jet-recorded matter on a fabric having a high resistance to rubbing and a good dry-cleanability with the use of such an ink composition for ink jet recording and a liquid composition for making pigment fixed.

Also, known aqueous pigment inks are, when used as ink compositions for ink jet recording on a textile, substandard in terms of adhesiveness, color density, and color intensity. As for known pigment-dispersing components, there is the problem that an ink containing a substance having both a hydrophilic moiety and a hydrophobic moiety, such as a surfactant and a glycol ether, often experiences dispersant polymers' adsorption to and desorption from pigment molecules and thus is inferior in terms of dispersion stability, storage stability, and discharge stability. In general, to avoid blurs on recording media, aqueous inks should contain a substance having both a hydrophilic moiety and a hydrophobic moiety, such as a surfactant and a glycol ether. Without such a substance, the permeability of inks is insufficient, and this poses the problems that printed images often have a reduced quality and that the options of recording media ensuring uniform printing are limited.

Furthermore, known pigment-dispersing components have another problem that, when they are used with additives to be contained in the ink according to the present invention (acetylene-glycol-based or acetylene-alcohol-based surfactants, di/triethylene glycol monobutyl ether, (di)propylene glycol monobutyl ether, 1,2-alkylene glycol and mixtures of them), the resultant ink is poor in terms of long-term storage stability and reconstitution properties and thus rapidly dries in a nozzle of an ink jet head or the like, clogging the nozzle.

The present invention is a solution to the problems described above, and an object thereof is to provide a liquid composition for making pigment fixed having a high resistance to rubbing and a good dry-cleanability (a padding agent); an ink set including the liquid composition for making pigment fixed and an ink composition excellent in terms of color intensity, discharge stability, and adhesiveness so as to be suitably used in ink jet recording; a method for producing ink-jet-recorded matter on a fabric having a high resistance to rubbing and good dry-cleanability using the liquid composition for making pigment fixed and the ink composition; and ink-jet-recorded matter on a fabric produced by the method.

### Means for Solving the Problems

The present invention is as follows.

(1) A liquid composition for making pigment fixed, containing at least polymer fine particles synthesized using an alkyl (meth)acrylate and/or cyclic alkyl (meth)acrylate and a reactive compound having an ethylene-based unsaturated group and a reactive group, the glass transition temperature and acid value of the liquid composition being equal to or lower than −10° C. and equal to or lower than 100 mg KOH/g, respectively. (2) The liquid composition for making pigment fixed according to (1) above, wherein the reactive group is a block isocyanate or an oxazoline group.

(3) The liquid composition for making pigment fixed according to (1) or (2) above, wherein the content ratio of the alkyl (meth)acrylate and/or cyclic alkyl (meth)acrylate relative to the total mass of the polymer fine particles is equal to or higher than 70 mass %.

(4) The liquid composition for making pigment fixed according to any one of (1) to (3) above, wherein the alkyl (meth)acrylate and/or cyclic alkyl (meth)acrylate is an alkyl (meth)acrylate having 1 to 24 carbon atoms and/or cyclic alkyl (meth)acrylate having 3 to 24 carbon atoms.

(5) The liquid composition for making pigment fixed according to any one of (1) to (4) above, wherein the styrene-based weight average molecular weight of the polymer fine particles measured by gel permeation chromatography (GPC) is in the range of 100000 to 1000000.

(6) An ink set including an ink composition and the liquid composition for making pigment fixed according to any one of (1) to (5) above, wherein:

the ink composition contains a dispersion component containing water and a pigment dispersed in the water.

(7) The ink set according to (6) above, wherein the dispersion component has an average particle diameter in the range of 50 to 300 nm.

(8) The ink set according to (7) above, wherein the dispersion component is a self-dispersing carbon black having an ability to be dispersed in water without a dispersant and an average particle diameter in the range of 50 to 300 nm.

(9) The ink set according to (8) above, wherein the dispersion component contains water and an organic pigment dispersed in the water using a polymer and has an average particle diameter in the range of 50 to 300 nm, and the styrene-based weight average molecular weight of the polymer measured by gel permeation chromatography (GPC) is in the range of 10000 to 200000.

(10) The ink set according to any one of (6) to (9) above, wherein the ink composition contains a 1,2-alkylene glycol.

(11) The ink set according to any one of (6) to (10) above, wherein the ink composition contains an acetylene-glycol-based surfactant and/or acetylene-alcohol-based surfactant.

(12) The ink set according to any one of (6) to (11) above, wherein the content ratio of the polymer fine particles (mass %) is higher than the content ratio of the pigment (mass %). (13) A method for producing ink-jet-recorded matter on a fabric, including:

a step of printing an ink composition containing a dispersion component containing water and a pigment dispersed in the water on a fabric by ink jet;

a step of immersing the obtained print in the liquid composition for making pigment fixed according to any one of (1) to (5) above; and

a step of heating the immersed print at a temperature in the range of 110 to 200° C. for at least one minute.

(14) A method for producing ink-jet-recorded matter on a fabric, including:

a step of printing an ink composition containing a dispersion component containing water and a pigment dispersed in the water on a fabric by ink jet;

a step of applying the liquid composition for making pigment fixed according to any one of (1) to (5) above to the obtained print by ink jet; and

a step of heating the print with the liquid composition applied thereto at a temperature in the range of 110 to 200° C. for at least one minute.

(15) The method for producing ink-jet-recorded matter on a fabric according to (13) or (14) above, wherein the dispersion component has an average particle diameter in the range of 50 to 300 nm.

(16) The method for producing ink-jet-recorded matter on a fabric according to (15) above, wherein the dispersion component is a self-dispersing carbon black having an ability to be dispersed in water without a dispersant and an average particle diameter in the range of 50 to 300 nm.

(17) The method for producing ink-jet-recorded matter on a fabric according to (15) above, wherein the dispersion component contains water and an organic pigment dispersed in the water using a polymer and has an average particle diameter in the range of 50 to 300 nm, and the styrene-based weight average molecular weight of the polymer measured by gel permeation chromatography (GPC) is in the range of 10000 to 200000.

(18) The method for producing ink-jet-recorded matter on a fabric according to any one of (13) to (17) above, wherein the ink composition contains a 1,2-alkylene glycol.

(19) The method for producing ink-jet-recorded matter on a fabric according to any one of (13) to (18) above, wherein the ink composition contains an acetylene-glycol-based surfactant and/or acetylene-alcohol-based surfactant.

(20) The method for producing ink-jet-recorded matter on a fabric according to any one of (13) to (19) above, wherein the content ratio of the polymer fine particles (mass %) is higher than the content ratio of the pigment (mass %). (21) Ink-jet-recorded matter on a fabric obtained by the method for producing ink-jet-recorded matter on a fabric according to any one of (13) to (20) above.

### DETAILED DESCRIPTION OF THE PRESENT INVENTION

### Liquid Composition for Making Pigment Fixed

The liquid composition for making pigment fixed according to the present invention has a glass transition temperature equal to or lower than −10° C., an acid value equal to or lower than 100 mg KOH/g, and contains at least a reactive compound having an ethylene-based unsaturated group and a reactive group and polymer fine particles synthesized from an alkyl (meth)acrylate and/or cyclic alkyl (meth)acrylate. This configuration provides the resultant ink-jet-recorded matter on a fabric with an improved resistance to both dry rubbing and wet rubbing and an improved dry-cleanability.

Hereinafter, the individual components are described.

Polymer Fine Particles

The glass transition temperature of the polymer fine particles is equal to or lower than −10° C. This improves the adhesiveness of the pigment in the ink-jet-recorded matter on a fabric. The adhesiveness of the pigment gradually decreases as the glass transition temperature, being higher than −10° C., increases. The glass transition temperature is preferably equal to or lower than −15° C. and more preferably equal to or lower than −20° C.

The acid value of the polymer fine particles is equal to or lower than 100 mg KOH/g. When the acid value is higher than 100 mg KOH/g, the resultant ink-jet-recorded matter on a fabric has a reduced resistance to washing. The acid value is preferably equal to or lower than 50 mg KOH/g and more preferably equal to or lower than 30 mg KOH/g.

The molecular weight of the polymer fine particles is preferably equal to or greater than 100000 and more preferably equal to or greater than 200000. When the molecular weight is less than 100000, the resultant ink-jet-recorded matter on a fabric has a reduced resistance to washing.

The alkyl (meth)acrylate and/or cyclic alkyl (meth)acrylate contained in the polymer fine particles is preferably an alkyl (meth)acrylate having 1 to 24 carbon atoms and/or cyclic alkyl (meth)acrylate having 3 to 24 carbon atoms. Examples of the alkyl (meth)acrylate and/or cyclic alkyl (meth)acrylate include methyl (meth)acrylate, ethyl (meth)acrylate, propyl (meth)acrylate, n-butyl (meth)acrylate, isobutyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate, t-butylcyclohexyl (meth)acrylate, lauryl (meth)acrylate, isobornyl (meth)acrylate, cetyl (meth)acrylate, stearyl (meth)acrylate, isostearyl (meth)acrylate, tetramethylpiperidyl (meth)acrylate, dicyclopentanyl (meth)acrylate, dicyclopentenyl (meth)acrylate, dicyclopentenyloxy (meth)acrylate, and behenyl (meth)acrylate.

The content ratio of the alkyl (meth)acrylate and/or cyclic alkyl (meth)acrylate relative to the total mass of the polymer fine particles is preferably equal to or higher than 70 mass %. This is because the alkyl (meth)acrylate and/or cyclic alkyl (meth)acrylate contained at such a content ratio provides the resultant ink-jet-recorded matter on a fabric with an improved resistance to both dry rubbing and wet rubbing and an improved dry-cleanability.

The reactive group existing in the reactive compound contained in the polymer fine particles is a reactive group that reacts with a functional group of a fabric (e.g., a hydroxyl group of cellulose), a functional group of the polymer fine particles, a functional group of the dispersion component (e.g., a resin), or the like during an appropriate treatment, for example, heating. The number of the reaction group existing in the reactive compound is at least one and may be two or more. On the other hand, the ethylene-based unsaturated group existing in the reactive compound reacts with the alkyl (meth)acrylate and/or cyclic acryl (meth)acrylate, another component of the polymer fine particles.

The reactive group includes not only groups that are reactive in themselves but also compounds that are inert in themselves but can be activated by an appropriate treatment such as heating; for example, a block isocyanate. The block isocyanate is produced by allowing free isocyanate groups of a precursor having isocyanate groups at the end thereof to react with a compound having an active hydrogen group (a blocker); it is inert at room temperature but, when heated, is decomposed into the blocker and the moiety having the isocyanate groups.

According to the present invention, the liquid composition for making pigment fixed preferably has a block isocyanate or an oxazoline group as the reactive group so that it may be used in ink jet recording on textiles.

Examples of applicable ethylene-based unsaturated groups existing in the reactive compound, a component of the polymer fine particles, include a vinyl group and a (meth)acrylloyl group.

Commercially available examples of block isocyanates having the ethylene-based unsaturated group that is a component of the polymer fine particles include Karenz MOI-BM and Karenz MOI-BP manufactured by Showa Denko K.K.

Examples of compounds having the ethylene-based unsaturated group and the oxazoline group include ricinol oxazoline (meth)acrylate, 2-vinyl-2-oxazoline, 4,4-dimethyl-2-vinyl-2-oxazoline, 4,4-dimethyl-2-isopropenyl-2-oxazoline, 5-methyl-2-vinyl-2-oxazoline, and 2-isopripenyl-2-oxazoline. In particular, ricinol oxazoline (meth)acrylate is preferable.

The styrene-based weight average molecular weight of the polymer fine particles measured by gel permeation chromatography (GPC) is preferably in the range of 100000 to 1000000. When the molecular weight falls within this range, the pigment in the ink-jet-recorded matter on a fabric has an improved adhesiveness.

The average diameter of the polymer fine particles is measured by light scattering. The average diameter of the polymer fine particles measured by light scattering is preferably in the range of 50 to 500 nm and more preferably in the range of 60 to 300 nm. When the average diameter is smaller than 50 nm, the resultant ink-jet-recorded matter on a fabric has a reduced adhesiveness. An average diameter greater than 500 nm would not only reduce the dispersion stability of the resultant ink-jet-recorded matter on a fabric but also, during ink jet printing of the liquid composition for making pigment fixed, disturb the discharge from an ink jet head.

Other Components

As described above, the liquid composition for making pigment fixed according to the present invention is used in the method for producing ink-jet-recorded matter on a fabric according to the present invention. In this method, an ink composition containing a dispersion component containing water and a pigment dispersed in the water is recorded on a fabric by ink jet printing, and then (A) the obtained print is immersed in the liquid composition for making pigment fixed or (B) the liquid composition for making pigment fixed is applied to the obtained print by ink jet.

The liquid composition for making pigment fixed according to the present invention may contain not only the essential components but also the component of the ink composition for ink jet recording described later, namely, a 1,2-alkylene glycol, a glycol ether, or an acetylene-glycol-based surfactant and/or acetylene-alcohol-based surfactant.

[Ink Set]

The ink set according to the present invention is an ink set including an ink composition and the liquid composition for making pigment fixed described above, wherein the ink composition contains a dispersion component containing water and a pigment dispersed in the water.

Hereinafter, the individual components of the ink composition are described. Note that the ink composition described below can be used as an ink composition for ink jet recording.

Pigment-Dispersing Component

The average particle diameter of the pigment-dispersing component is measured by light scattering. When the average particle diameter is smaller than 50 nm, the resultant prints and ink-jet-recorded matter on fabrics have a reduced intensity of colors. When the average particle diameter is greater than 300 nm, the resultant prints and ink-jet-recorded matter on fabrics have a reduced adhesiveness. The average particle diameter is more preferably in the range of 70 to 230 nm and much more preferably in the range of 80 to 130 nm.

The pigment-dispersing component is preferably a self-dispersing carbon black having an ability to be dispersed in water without a dispersant and an average particle diameter in the range of 50 to 300 nm. The use of such a self-dispersing carbon black improves the color intensity of the resulting ink-jet-recorded matter on a fabric. The method for providing a carbon black with an ability to be dispersed in water without a dispersant is, for example, the oxidation of the surface of the carbon black particles with ozone, sodium hypochlorite, or the like. The pigment-dispersing component containing such a self-dispersing carbon black preferably has an average particle diameter in the range of 50 to 150 nm. When the average particle diameter is smaller than 50 nm, the resultant ink-jet-recorded matter on a fabric has a reduced intensity of colors. As the average particle diameter, being greater than 150 nm, increases, the resultant ink-jet-recorded matter on a fabric has a decreasing adhesiveness. The average particle diameter is more preferably in the range of 70 to 130 nm and much more preferably in the range of 80 to 120 nm.

Meanwhile, it is preferable that the liquid composition for making pigment fixed contains water and an organic pigment dispersed in the water using a polymer and has an average particle diameter in the range of 50 to 300 nm and that the styrene-based weight average molecular weight of the polymer measured by gel permeation chromatography (GPC) is in the range of 10000 to 200000. This improves the adhesiveness of the pigment in the ink-jet-recorded matter on a fabric and the storage stability of the pigment ink itself. To be dispersed stably in the resultant ink, the liquid composition for making pigment fixed may further contain, as well as the polymer described above, a water-dispersible or water-soluble polymer or a surfactant as a dispersion stabilizer. Note that the polymer preferably contains a copolymer of a (meth)acrylate and a (meth)acrylic acid accounting for at least 70% of the total mass of the polymer. This is because such a polymer is favorable in terms of dispersion stability.

Particularly preferred examples of the pigment for a black ink include carbon black (C.I. Pigment Black 7) such as furnace black, lamp black, acetylene black, and channel black; however, metal compounds such as copper oxide, iron oxide (C.I. Pigment Black 11), and titanium oxide and organic pigments such as aniline black (C.I. Pigment Black 1) may be used instead.

Examples of the pigment for a color ink include C.I. Pigment Yellow 1 (Fast Yellow G), 3, 12 (Disazo Yellow AAA), 13, 14, 17, 24, 34, 35, 37, 42 (yellow iron oxide), 53, 55, 74, 81, 83 (Disazo Yellow HR), 93, 94, 95, 97, 98, 100, 101, 104, 108, 109, 110, 117, 120, 128, 138, 153, 155, 180, and 185; C.I. Pigment Red 1, 2, 3, 5, 17, 22 (Brilliant First Scarlet), 23, 31, 38, 48:2 (Permanent Red 2B (Ba)), 48:2 (Permanent Red 2B (Ca)), 48:3 (Permanent Red 2B (Sr)), 48:4 (Permanent Red 2B (Mn)), 49:1, 52:2, 53:1, 57:1 (Brilliant Carmine 6B), 60:1, 63:1, 63:2, 64:1, 81 (Rhodamine 6G lake), 83, 88, 101 (red iron oxide), 104, 105, 106, 108 (cadmium red), 112, 114, 122 (quinacridone magenta), 123, 146, 149, 166, 168, 170, 172, 177, 178, 179, 185, 190, 193, 202, 206, 209, and 219; C.I. Pigment Violet 19 and 23; C.I. Pigment Orange 36; C.I. Pigment Blue 1, 2, 15 (phthalocyanine blue R), 15:1, 15:2, 15:3 (phthalocyanine blue G), 15:4, 15:6 (phthalocyanine blue E), 16, 17:1, 56, 60, and 63; and C.I. Pigment Green 1, 4, 7, 8, 10, 17, 18, and 36, suggesting that various pigments can be used as a colorant.

The pigment is dispersed using a dispersing apparatus. As the dispersing apparatus, various commercially available ones may be used. However, the dispersing apparatus preferably operates on the principle of dispersion using no medium. Specific examples of applicable dispersion apparatuses include a wet jet mill (Genus), Nanomarzer (Nanomarzer), a homogenizer (Gaulin), Ultimizer (Sugino Machine Limited), and Microfluidizer (Microfluidics International Corporation).

The content ratio of the pigment is preferably in the range of 0.5 to 30 mass % (hereinafter, “mass %” may be abbreviated as “%”) and more preferably in the range of 1.0 to 15 mass %. When the content ratio is lower than 0.5 mass %, sufficient darkness of printing is not ensured. When the content ratio is higher than 30 mass %, the resultant ink has an increased viscosity or a structural viscosity, and this often results in instable discharge of the ink from an ink jet head.

1,2-Alkylene Glycol

The ink composition according to the present invention preferably contains a 1,2-alkylene glycol. The use of the 1,2-alkylene glycol reduces blurs occurring on the resultant prints or ink-jet-recorded matter on fabrics, thereby improving printing quality. Preferred examples of applicable 1,2-alkylene glycols include 1,2-alkylene glycols having five or six carbon atoms such as 1,2-hexanediol, 1,2-pentanediol, and 4-methyl-1,2-pentanediol. Among others, 1,2-hexanediol and 4-methyl-1,2-pentanediol, both having six carbon atoms, are particularly preferable. The content ratio of the 1,2-alkylene glycol is preferably in the range of 0.3 to 30 mass % and more preferably in the range of 0.5 to 10 mass %.

Glycol Ether

The ink composition according to the present invention preferably contains a glycol ether. This is because the use of the glycol ether reduces blurs occurring on the resultant prints or ink-jet-recorded matter on fabrics. The glycol ether is preferably one or more compounds selected from diethylene glycol monobutyl ether, triethylene glycol monobutyl ether, propylene glycol monobutyl ether, and dipropylene glycol monobutyl ether. The content ratio of the glycol ether is preferably in the range of 0.1 to 20 mass % and more preferably in the range of 0.5 to 10 mass %.

Acetylene-Glycol-Based Surfactant and/or Acetylene-Alcohol-Based Surfactant

The ink composition according to the present invention preferably contains an acetylene-glycol-based surfactant and/or acetylene-alcohol-based surfactant. The use of the acetylene-glycol-based surfactant and/or acetylene-alcohol-based surfactant not only further reduces blurs, thereby further improving printing quality, but also improves the drying rate of the resultant ink, thereby enabling high-speed printing.

The acetylene-glycol-based surfactant and/or acetylene-alcohol-based surfactant is preferably one or more compounds selected from 2,4,7,9-tetramethyl-5-decyne-4,7-diol, 2,4,7,9-tetramethyl-5-decyne-4,7-diol having an alkylene oxide added thereto, 2,4-dimethyl-5-decyne-4-ol, and 2,4-dimethyl-5-decyne-4-ol having an alkylene oxide added thereto. Commercially available examples of such compounds include OLFINE 104 products and OLFINE E products, such as OLFINE E1010, manufactured by Air Products and Chemicals, Inc. (UK) and Surfynol 465 and Surfynol 61 manufactured by Nissin Chemical Industry Co., Ltd.

To reduce blurs, the present invention contains one or more compounds selected from the group consisting of the 1,2-alkylene glycol, glycol ether, and acetylene-glycol-based surfactant and/or acetylene-alcohol-based surfactant.

In the ink set according to the present invention, the total content ratio of the polymer fine particles (mass %), which is a component of the liquid composition for making pigment fixed, is higher than the content ratio of the pigment (mass %), which is a component of the ink composition. This improves the adhesiveness of the pigment in the resultant ink-jet-recorded matter on a fabric.

In addition, the ink composition according to the present invention may further contain appropriate additives such as a humectant, a dissolution aid, a permeation-controlling agent, a viscosity adjuster, a pH adjuster, a dissolution aid, an antioxidant, an antiseptic, a fungicide, an anticorrosive, a chelating agent for trapping metal ions that may affect dispersion, and so forth in order to ensure the stability thereof when the ink is allowed to stand, stabilize the discharge of the ink from an ink jet head, prevent clogging, and prevent the degradation of the ink.

[Method for Producing Ink-Jet-Recorded Matter on a Fabric]

The method for producing ink-jet-recorded matter on a fabric according to the present invention includes a step of recording an ink composition containing a dispersion component containing water and a pigment dispersed in the water on a fabric by ink jet; a step of immersing the obtained print in the liquid composition for making pigment fixed described above; and a step of heating the immersed print at a temperature in the range of 110 to 200° C. for at least one minute.

Also, the method for producing ink-jet-recorded matter on a fabric according to the present invention includes a step of recording an ink composition containing a dispersion component containing water and a pigment dispersed in the water on a fabric by ink jet; a step of applying the liquid composition for making pigment fixed described above to the obtained print by ink jet; and a step of heating the print with the liquid composition applied thereto at a temperature in the range of 110 to 200° C. for at least one minute.

The ink composition and the liquid composition for making pigment fixed are as described earlier.

When the heating temperature is lower than 110° C., the adhesiveness of the resultant ink-jet-recorded matter on a fabric is not improved. When the heating temperature is higher than 200° C., the fabric, pigment, polymer, and so forth are damaged. The heating temperature is preferably in the range of 120 to 170° C. Furthermore, the duration of heating should be at least one minute. When the duration of heating is shorter than one minute, the block isocyanate, oxazoline group, or other reactive groups existing in the polymer fine particles contained in the liquid composition for making pigment fixed reacts incompletely. The duration of heating is preferably equal to or longer than two minutes.

This method preferably includes a step of washing the print in water or surfactant-containing water between the ink jet printing step and the immersion/application step. During this washing step, water-soluble components of the ink are washed away from the print, so that the polymer fine particles adhere to the fabric more strongly and that the resultant ink-jet-recorded matter on a fabric has an improved resistance to rubbing.

When the ink composition is printed on a fabric, the ink is preferably discharged using a method based on an electrostrictive element generating no heat, such as a piezoelectric element. This is because the use of a heat-generating device, such as a thermal head, denatures the polymer fine particles contained in the liquid composition for making pigment fixed and the polymer used to disperse the pigment in the ink, and this often leads to instable discharge. Manufacturing processes necessitating that a large amount of ink is discharged for a long period of time, such as the production of ink-jet-recorded matter on a fabric, do not prefer such a heat-generating head.

[Ink-Jet-Recorded Matter on a Fabric]

The ink-jet-recorded matter on a fabric is obtained by the method for producing ink-jet-recorded matter on a fabric described above.

### EXAMPLES

Hereinafter, the present invention is described in more detail with reference to examples and so forth; however, the present invention is never limited to these examples. Note that “parts” and “%” used in the compositions of the following examples refer to “parts by mass” and “mass %,” respectively, unless otherwise specified.

### Example A-1

### (1) Preparation of an Ink for Ink Jet Recording

An ink for ink jet recording was prepared by producing pigment-dispersing component A1 by the method described later and then mixing it with the vehicle components shown in Table 2. Note that “ion-exchange water (balance)” presented in the composition of the inks of this example, other examples, comparative examples, and reference examples included in Examples A contained Topside 240 (manufactured by Permachem Asia, Ltd.) for preventing the corrosion of the ink at 0.05%, benzotriazol for preventing the corrosion of an ink jet head at 0.02%, and EDTA (ethylene diamine tetraacetic acid).2Na for reducing the influence of metal ions existing in the ink at 0.04%.

Production of Pigment-Dispersing Component A1

As a material of pigment-dispersing component A1, MONARCH 880, a carbon black (Pigment Black 7) manufactured by Cabot Corporation in the United States, was used. According to the method described in Japanese Unexamined Patent Application Publication No. H8-3498, the surface of the carbon black was oxidized so that the carbon black may be dispersed in water, and the obtained product was designated as dispersion component A1. The particle diameter was determined using Microtrac UPA250 Particle Size Analyzer (manufactured by Nikkiso Co., Ltd.) to be 110 nm.

### (2) Preparation of a Liquid Composition for Making Pigment Fixed

A liquid composition for making pigment fixed was prepared by producing the aqueous emulsion of polymer fine particles (emulsion AA) by the method described later and then mixing it with the vehicle components shown in Table 3. Note that “ion-exchange water (balance)” presented in the composition of the liquid compositions for making pigment fixed in this example, other examples, comparative examples, and reference examples included in Examples A contained Topside 240 (manufactured by Permachem Asia, Ltd.) for preventing the corrosion of the ink at 0.05%, benzotriazol for preventing the corrosion of an ink jet head at 0.02%, and EDTA (ethylene diamine tetraacetic acid).2Na for reducing the influence of metal ions existing in the ink at 0.04%.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.2 parts of potassium persulfate, a polymerization initiator, was added thereto. Separately, a monomer solution was prepared by mixing 7 parts of ion-exchange water with 0.05 part of sodium lauryl sulfate, 4 parts of glycidoxy acrylate, 15 parts of ethyl acrylate, 15 parts of butyl acrylate, 6 parts of tetrahydrofurfuryl acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 30 parts of ethyl acrylate, 25 parts of methyl acrylate, 6 parts of Karenz MOI-BM manufactured by Showa Denko K.K., 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion AA (EM-AA). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −15° C. Then, the styrene-based molecular weight of the polymer fine particle was measured by gel permeation chromatography (GPC) using L7100 System manufactured by Hitachi, Ltd. and THF as solvent. The styrene-based molecular weight was 150000. Subsequently, the acid value was measured by titration to be 20 mg KOH/g.

### (3) Method for Producing Ink-Jet-Recorded Matter on a Fabric

Using the ink described above, a solid image was printed on a fabric. The ink jet printer used was PX-V600 manufactured by Seiko Epson Corporation. On the obtained print, a solid image was printed using the liquid composition for making pigment fixed and the same printer. The obtained print was heated at 150° C. for five minutes to obtain sample ink-jet-recorded matter on a fabric.

### (4) Tests for Resistance to Rubbing and Dry-Cleanability

The obtained sample (ink-jet-recorded matter on a fabric) was subjected to resistance to rubbing, in which the sample was rubbed 200 times with a load of 300 g using a color fastness rubbing tester AB-301S manufactured by Tester Sangyo Co., Ltd. Detachment of the ink was evaluated after two types of rubbing, namely dry rubbing and wet rubbing, in accordance with Japanese Industrial Standards (JIS) JIS L0849. Furthermore, the dry-cleanability was tested and evaluated in accordance with Method B of JIS L0860. The results of the tests for resistance to rubbing and dry-cleanability are shown in Table 1.

### (5) Measurement of Discharge Stability

Using PX-V600, an ink jet printer manufactured by Seiko Epson Corporation, and the ink composition for ink jet recording, letters were printed on Xerox P A4 paper manufactured by Fuji Xerox Co., Ltd. under the following conditions: atmosphere: 35° C./35%; software: Microsoft Word; font: 11 points of MS P Gothic with no additional styles; the number of letters: 4000 letters/page; and the number of pages: 100 pages. The result is shown in Table 1. The evaluation criteria were as follows: AA: no deformed letters; A: one deformed letter; B: two or three deformed letters; C: four or five deformed letters; and D: six or more deformed letters.

### Example A-2

### (1) Preparation of an Ink for Ink Jet Recording

An ink for ink jet recording was prepared by producing pigment-dispersing component A2 by the method described below and then mixing it with the vehicle components shown in Table 2.

Production of Pigment-Dispersing Component A2

As a material of pigment-dispersing component A2, Pigment Blue 15:3 (a copper phthalocyanine pigment manufactured by Clariant) was used. A stirrer, a thermometer, a reflux tube, and a dripping funnel were attached to a reaction vessel, and then the reaction vessel was filled with nitrogen. Into this reaction vessel, 75 parts of benzyl acrylate, 2 parts of acrylic acid, and 0.3 part of t-dodecylmercaptan were put, and then the reaction vessel was heated to 70° C. Separately, 150 parts of benzyl acrylate, 15 parts of acrylic acid, 5 parts of butyl acrylate, 1 part of t-dodecylmercaptan, 20 parts of methyl ethyl ketone, and 1 part of sodium persulfate were put into the dripping funnel. The content of the dripping funnel was dropped in the reaction vessel for four hours to polymerize dispersing polymer molecules. Subsequently, methyl ethyl ketone was added to the reaction vessel to prepare a 40% dispersive-polymer solution. A portion of this polymer was dried and then subjected to the measurement of glass transition temperature using a differential operation calorimeter (EXSTAR6000DSC manufactured by Seiko Instruments, Inc.). The glass transition temperature was 40° C.

Then, 40 parts of the dispersive-polymer solution was mixed with 30 parts of Pigment Blue 15:3, 100 parts of a 0.1 mol/L sodium hydroxide solution, and 30 parts of methyl ethyl ketone. The obtained mixture was put into an ultrahigh-pressure homogenizer (Ultimizer HJP-25005 manufactured by Sugino Machine Limited) and allowed to pass the homogenizer 15 times at 200 MPa so as to be dispersed. The obtained dispersion solution was transferred to another vessel, 300 parts of ion-exchange water was added thereto, and then the content of the vessel was stirred for one hour. Using a rotary evaporator, the entire volume of methyl ethyl ketone and a portion of water were distilled away. The residue was neutralized with a 0.1 mol/L sodium hydroxide until pH thereof was 9. The obtained product was filtered through a 0.3-μm membrane filter and conditioned by adding ion-exchange water until the pigment concentration was 15%. The obtained product was designated as pigment-dispersing component A2. The particle diameter was measured by the method used in Example A-1 to be 80 nm.

### (2) Preparation of a Liquid Composition for Making Pigment Fixed

A liquid composition for making pigment fixed was prepared by producing the aqueous emulsion of polymer fine particles (emulsion AB) by the method described later and then mixing it with the vehicle components shown in Table 3.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.2 parts of potassium persulfate, a polymerization initiator, was added thereto. Separately, a monomer solution was prepared by mixing 7 parts of ion-exchange water with 0.05 part of sodium lauryl sulfate, 19 parts of ethyl acrylate, 15 parts of butyl acrylate, 6 parts of tetrahydrofurfuryl acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 30 parts of ethyl acrylate, 25 parts of methyl acrylate, 10 parts of butyl acrylate, 6 parts of Karenz MOI-BM manufactured by Showa Denko K.K., 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion AB (EM-AB). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −17° C. Then, the molecular weight of the polymer fine particle was measured by the method used in Example A-1. The molecular weight was 200000. Subsequently, the acid value was measured by titration to be 20 mg KOH/g.

### (3) Method for Producing Ink-Jet-Recorded Matter on a Fabric

Using the ink and liquid composition for making pigment fixed of Example A-2, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 1.

### (5) Measurement of Discharge Stability

The ink of Example A-2 was assessed for discharge stability by the method and evaluation criteria used in Example A-1. The result of discharge stability measurement is shown in Table 1.

### Example A-3

### (1) Preparation of an Ink for Ink Jet Recording

An ink for ink jet recording was prepared by producing pigment-dispersing component A3 by the method described below and then mixing it with the vehicle components shown in Table 2.

Production of Pigment-Dispersing Component A3

As a material of pigment-dispersing component A3, Pigment Violet 19 (a quinacridone pigment manufactured by Clariant) was used. The production method was the same as that used to produce pigment-dispersing component A2. The particle diameter was measured by the method used in Example A-1 to be 90 nm.

### (2) Preparation of a Liquid Composition for Making Pigment Fixed

A liquid composition for making pigment fixed was prepared by mixing emulsion AB obtained in Example A-2 with the vehicle components shown in Table 3.

### (3) Method for Producing Ink-Jet-Recorded Matter on a Fabric

Using the ink and liquid composition for making pigment fixed of Example A-3, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 1.

### (5) Measurement of Discharge Stability

The ink of Example A-3 was assessed for discharge stability by the method and evaluation criteria used in Example A-1. The result of discharge stability measurement is shown in Table 1.

### Example A-4

### (1) Preparation of an Ink for Ink Jet Recording

An ink for ink jet recording was prepared by producing pigment-dispersing component A4 by the method described below and then mixing it with the vehicle components shown in Table 2.

Production of Pigment-Dispersing Component A4

As a material of pigment-dispersing component A4, Pigment Yellow 14 (an azo pigment manufactured by Clariant) was used. The production method was the same as that used to produce pigment-dispersing component A2. The particle diameter was measured by the method used in Example A-1 to be 115 nm.

### (2) Preparation of a Liquid Composition for Making Pigment Fixed

A liquid composition for making pigment fixed was prepared by mixing emulsion AB obtained in Example A-2 with the vehicle components shown in Table 3.

### (3) Method for Producing Ink-Jet-Recorded Matter on a Fabric

Using the ink and liquid composition for making pigment fixed of Example A-4, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 1.

### (5) Measurement of Discharge Stability

The ink of Example A-4 was assessed for discharge stability by the method and evaluation criteria used in Example A-1. The result of discharge stability measurement is shown in Table 1.

### Comparative Example A-1

In Comparative Example A-1, a liquid composition for making pigment fixed was conditioned by the method used in Example A-1, except that, in preparing polymer fine particles, the entire volume (45 parts) of ethyl acrylate was changed to 45 parts of benzyl methacrylate so that the polymer fine particles may have had a glass transition temperature of 0° C. The emulsion produced using these polymer fine particles was designated as emulsion AC (EM-AC) The ingredients of the liquid composition for making pigment fixed are shown in Table 3. Also, the ink of Comparative Example A-1 was conditioned using the pigment-dispersing component used in Example A-1. The composition of the ink is shown in Table 2. The sample ink-jet-recorded matter on a fabric was conditioned by the method used in Example A-1, and the obtained sample was subjected to the tests for resistance to rubbing, dry-cleanability, and discharge stability conducted in Example A-1. The results are shown in Table 1.

### Comparative Example A-2

In Comparative Example A-2, a liquid composition for making pigment fixed was prepared by the method used in Example A-2, except that, in preparing polymer fine particles, the entire volume (49 parts) of ethyl acrylate was changed to benzyl methacrylate and 10 parts of butyl acrylate was changed to 10 parts of benzyl methacrylate so that the polymer fine particles may have had a glass transition temperature of 10° C. The emulsion produced using these polymer fine particles was designated as emulsion AD (EM-AD). The ingredients of the liquid composition for making pigment fixed are shown in Table 3. Also, the ink of Comparative Example A-2 was conditioned using the pigment-dispersing component used in Example A-2. The composition of the ink is shown in Table 2. The sample ink-jet-recorded matter on a fabric was conditioned by the method used in Example A-1, and the obtained sample was subjected to the tests for resistance to rubbing, dry-cleanability, and discharge stability conducted in Example A-1. The results are shown in Table 1.

### Reference Example A-3

In Reference Example A-3, inks were prepared by the method used in Example A-3, except that pigment-dispersing components had a particle diameter of 350 nm or 45 nm. The particle diameter was measured by the method used in Example A-1. The pigment-dispersing component having a particle diameter of 350 nm was designated as pigment-dispersing component A3A, whereas the pigment-dispersing component having a particle diameter of 45 nm was designated as pigment-dispersing component A3B. Note that the liquid compositions for making pigment fixed used in Reference Example A-3 are equivalent to that used in Example A-3. The ingredients of the liquid compositions for making pigment fixed are shown in Table 3. The sample ink-jet-recorded matter on a fabric was conditioned by the method used in Example A-1, and the obtained samples were subjected to the tests for resistance to rubbing, dry-cleanability, and discharge stability conducted in Example A-1. The results are shown in Table 1.

### Comparative Example A-4

In Comparative Example A-4, liquid compositions for making pigment fixed were prepared by the method used in Example A-4, except that the polymer fine particles had an acid value of 120 or 150 mg KOH/g. The emulsion produced using the polymer fine particles having an acid value of 120 mg KOH/g was designated as emulsion AE (EM-AE), whereas the emulsion produced using the polymer fine particles having an acid value of 150 mg KOH/g was designated as emulsion AF (EM-AF). The ingredients of the liquid compositions for making pigment fixed are shown in Table 3. Also, the inks of Comparative Example A-4 were equivalent to that of Example A-4. The compositions of the inks are shown in Table 2. The sample ink-jet-recorded matter on a fabric was conditioned by the method used in Example A-1, and the obtained samples were subjected to the tests for resistance to rubbing, dry-cleanability, and discharge stability conducted in Example A-1. The results are shown in Table 1.

### Comparative Example A-5

In Comparative Example A-5, a liquid composition for making pigment fixed was prepared by the method used in Example A-2, except that the block isocyanate having a (meth)acryloyl group (Karenz MOI-BM manufactured by Showa Denko K.K.) was excluded. The emulsion produced using polymer fine particles containing no block isocyanate having a (meth)acryloyl group (Karenz MOI-BM manufactured by Showa Denko K.K.) was designated as emulsion AG (EM-AG). The ingredients of the liquid composition for making pigment fixed are shown in Table 3. Also, the ink of Comparative Example A-5 was equivalent to that of Example A-2. The composition of the ink is shown in Table 2. The sample ink-jet-recorded matter on a fabric was conditioned by the method used in Example A-1, and the obtained sample was subjected to the tests for resistance to rubbing, dry-cleanability, and discharge stability conducted in Example A-1. The results are shown in Table 1.

### Comparative Example A-6

In Comparative Example A-6, a liquid composition for making pigment fixed was prepared by the method used in Example A-3, except that the block isocyanate having a (meth)acryloyl group (Karenz MOI-BM manufactured by Showa Denko K.K.) was excluded. The ingredients of the liquid composition for making pigment fixed are shown in Table 3. Also, the ink of Comparative Example A-6 was equivalent to that of Example A-3. The composition of the ink is shown in Table 2. The sample ink-jet-recorded matter on a fabric was conditioned by the method used in Example A-1, and the obtained sample was subjected to the tests for resistance to rubbing, dry-cleanability, and discharge stability conducted in Example A-1. The results are shown in Table 1.

TABLE 1
Results of Resistance to Rubbing, Dry-cleanability, and Discharge
Stability Obtained from Examples A-1 to A-4, Comparative Examples
A-1, A-2, and A-4 to A-6, and Reference Example A-3

| | | | | Resistance | | Dry- | Dis- |
|---|---|---|---|---|---|---|---|
| | | Particle | Acid | to rubbing | | cleana- | charge |
| | Tg | diameter | value | Dry | Wet | bility | stability |
| Example A-1 | −15 | 110 | 20 | ¾ | ¾ | ⅘ | A |
| Example A-2 | −17 | 80 | 20 | 5 | ⅘ | 5 | A |
| Example A-3 | −17 | 90 | 20 | 5 | 5 | 5 | A |
| Example A-4 | −17 | 115 | 20 | 5 | 5 | 5 | A |
| Comparative | 0 | 110 | 20 | 3 | 2 | ⅔ | A |
| Example A-1 | | | | | | | |
| Comparative | 10 | 80 | 20 | ⅔ | ⅔ | 2 | A |
| Example A-2 | | | | | | | |
| Reference | −17 | 350 | 20 | 2 | 2 | ⅔ | D |
| Example A-3 | −17 | 45 | 20 | ¾ | ¾ | 4 | C |
| Comparative | −17 | 115 | 120 | 3 | 3 | 3 | A |
| Example A-4 | −17 | 115 | 150 | ⅔ | ⅔ | ¾ | A |
| Comparative | −17 | 80 | 20 | 2 | ½ | 5 | A |
| Example A-5 | | | | | | | |
| Comparative | −17 | 90 | 20 | 3 | ⅔ | 5 | A |
| Example A-6 | | | | | | | |

The unit of Tg is ° C.;
the particle diameter is an average particle diameter of the pigment in nm; and
the unit of the acid value is mg KOH/g.
The resistance to rubbing and dry-cleanability were evaluated in accordance with JIS acceptance criteria.

TABLE 2
Composition of Inks of Examples A-1 to A-4, Comparative Examples A-1, A-2, and
A-4 to A-6, and Reference Example A-3 (wt %)

| | | | | | Comparative | | Reference | | Comparative | | | |
|---|---|---|---|---|---|---|---|---|---|---|---|---|
| | Example | | | | Example | | Example | | Example | | | |
| | A-1 | A-2 | A-3 | A-4 | A-1 | A-2 | A-3 | | A-4 | | A-5 | A-6 |
| Dispersion | 4.5 | — | — | — | 4.5 | — | — | — | — | — | — | — |
| component A1 | | | | | | | | | | | | |
| Dispersion | — | 3.5 | — | — | — | 3.5 | — | — | — | — | 3.5 | — |
| component A2 | | | | | | | | | | | | |
| Dispersion | — | — | 4.5 | — | — | — | — | — | — | — | — | 4.5 |
| component A3 | | | | | | | | | | | | |
| Dispersion | — | — | — | 4.5 | — | — | — | — | 4.5 | 4.5 | — | — |
| component A4 | | | | | | | | | | | | |
| Dispersion | — | — | — | — | — | — | 4.5 | — | — | — | — | — |
| component A3A | | | | | | | | | | | | |
| Dispersion | — | — | — | — | — | — | — | 4.5 | — | — | — | — |
| component A3B | | | | | | | | | | | | |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerin | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion-exchange | Balance | Balance | Balance | Balance | Balance | Balance | Balance | Balance | Balance | Balance | Balance | Balance |
| water | | | | | | | | | | | | |

The concentrations of the pigments are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

TABLE 3
Ingredients of Liquid Compositions for Making Pigment Fixed of Examples A-1 to
A-4, Comparative Examples A-1, A-2, and A-4 to A-6, and Reference Example A-3 (wt %)

| | | | | | Comparative | | Reference | | Comparative | | | |
|---|---|---|---|---|---|---|---|---|---|---|---|---|
| | Example | | | | Example | | Example | | Example | | | |
| | A-1 | A-2 | A-3 | A-4 | A-1 | A-2 | A-3 | | A-4 | | A-5 | A-6 |
| EM-AA | 6.0 | — | — | — | — | — | — | — | — | — | — | — |
| EM-AB | — | 5.0 | 6.0 | 6.0 | — | — | 6.0 | 6.0 | — | — | — | — |
| EM-AC | — | — | — | — | 6.0 | — | — | — | — | — | — | — |
| EM-AD | — | — | — | — | — | 6.0 | — | — | — | — | — | — |
| EM-AE | — | — | — | — | — | — | — | — | 6.0 | — | — | — |
| EM-AF | — | — | — | — | — | — | — | — | — | 6.0 | — | — |
| EM-AG | — | — | — | — | — | — | — | — | — | — | 5.0 | 6.0 |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerin | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion-exchange | Balance | Balance | Balance | Balance | Balance | Balance | Balance | Balance | Balance | Balance | Balance | Balance |
| water | | | | | | | | | | | | |

The concentrations of the polymers are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

### Example A-5

### (1) Preparation of an Ink for Ink Jet Recording

An ink for ink jet recording was prepared by producing pigment-dispersing component A5 by the method described below and then mixing it with the vehicle components shown in Table 5.

Production of Pigment-Dispersing Component A5

As a material of pigment-dispersing component 5, MA100 manufactured by Mitsubishi Chemical Industries Corporation, a carbon black (PBk7), was used. According to the method described in Japanese Unexamined Patent Application Publication No. H8-3498, the surface of the carbon black was oxidized so that the carbon black may be dispersed in water, and the obtained product was designated as dispersion component A5. The particle diameter was measured by the method used in Example A-1 to be 120 nm.

### (2) Preparation of a Liquid Composition for Making Pigment Fixed

A liquid composition for making pigment fixed was prepared by producing the aqueous emulsion of polymer fine particles (emulsion A1) by the method described later and then mixing it with the vehicle components shown in Table 6.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.3 parts of potassium persulfate, a polymerization initiator, was added thereto. Separately, a monomer solution was prepared by mixing 7 parts of ion-exchange water with 0.05 part of sodium lauryl sulfate, 20 parts of ethyl acrylate, 15 parts of butyl acrylate, 6 parts of lauryl acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 24 parts of ethyl acrylate, 6 parts of Karenz MOI-BP manufactured by Showa Denko K.K., 25 parts of butyl acrylate, 16 parts of lauryl acrylate, 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion AI (EM-AI). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −19° C. Then, the molecular weight of the polymer fine particle was measured by the method used in Example A-1. The molecular weight was 180000. Subsequently, the acid value was measured by titration to be 18 mg KOH/g.

### (3) Method for Producing Ink-Jet-Recorded Matter on a Fabric

Using the ink and liquid composition for making pigment fixed of Example A-5, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 4.

### (5) Measurement of Discharge Stability

The ink of Example A-5 was assessed for discharge stability by the method and evaluation criteria used in Example A-1. The result of discharge stability measurement is shown in Table 4.

### Example A-6

### (1) Preparation of an Ink for Ink Jet Recording

An ink for ink jet recording was prepared by producing pigment-dispersing component A6 by the method described below and then mixing it with the vehicle components shown in Table 5.

Production of Pigment-Dispersing Component A6

As a material of pigment-dispersing component A6, Pigment Blue 15:3 (a copper phthalocyanine pigment manufactured by Clariant) was used. A stirrer, a thermometer, a reflux tube, and a dripping funnel were attached to a reaction vessel, and then the reaction vessel was filled with nitrogen. Into this reaction vessel, 45 parts of styrene, 30 parts of polyethylene glycol 400 acrylate, 10 parts of benzyl acrylate, 2 parts of acrylic acid, and 0.3 part of t-dodecylmercaptan were put, and then the reaction vessel was heated to 70° C. Separately, 150 parts of styrene, 100 parts of polyethylene glycol 400 acrylate, 15 parts of acrylic acid, 5 parts of butyl acrylate, 1 part of t-dodecylmercaptan, and 5 part of sodium persulfate were put into the dripping funnel. The content of the dripping funnel was dropped in the reaction vessel for four hours to polymerize dispersing polymer molecules. Subsequently, water was added to the reaction vessel to prepare a 40% dispersive-polymer solution. A portion of this polymer was dried and then subjected to the measurement of glass transition temperature using a differential operation calorimeter (EXSTAR6000DSC manufactured by Seiko Instruments, Inc.). The glass transition temperature was 45° C.

Then, 40 parts of the dispersive-polymer solution was mixed with 30 parts of Pigment Blue 15:3 (a copper phthalocyanine pigment manufactured by Clariant) and 100 parts of a 0.1 mol/L sodium hydroxide solution. The obtained mixture was dispersed for two hours using an Eiger mill containing zirconia beads. The obtained dispersion solution was transferred to another vessel, 300 parts of ion-exchange water was added thereto, and then the content of the vessel was stirred for one hour. The content of the vessel was neutralized with a 0.1 mol/L sodium hydroxide until pH thereof was 9. The product was filtered through a 0.3-μm membrane filter, and thus dispersion component A5 containing solid content (the dispersive polymer and Pigment Blue 15:3) at 20%. The particle diameter was measured by the method used in Example A-1 to be 100 nm. The molecular weight was measured to be 210000.

### (2) Preparation of a Liquid Composition for Making Pigment Fixed

A liquid composition for making pigment fixed was prepared by producing the aqueous emulsion of polymer fine particles (emulsion AJ) by the method described later and then mixing it with the vehicle components shown in Table 6.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.3 parts of potassium persulfate, a polymerization initiator, was added thereto. Separately, a monomer solution was prepared by mixing 7 parts of ion-exchange water with 0.05 part of sodium lauryl sulfate, 20 parts of ethyl acrylate, 25 parts of butyl acrylate, 6 parts of lauryl acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 14 parts of ethyl acrylate, 6 parts of Karenz MOI-BM manufactured by Showa Denko K.K., 20 parts of butyl acrylate, 20 parts of lauryl acrylate, 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion AJ (EM-AJ). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −21° C. Subsequently, the acid value was measured by titration to be 18 mg KOH/g.

### (3) Method for Producing Ink-Jet-Recorded Matter on a Fabric

Using the ink and liquid composition for making pigment fixed of Example A-6, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 4.

### (5) Measurement of Discharge Stability

The ink of Example A-6 was assessed for discharge stability by the method and evaluation criteria used in Example A-1. The result of discharge stability measurement is shown in Table 4.

### Example A-7

### (1) Preparation of an Ink for Ink Jet Recording

An ink for ink jet recording was prepared by producing pigment-dispersing component A7 by the method described below and then mixing it with the vehicle components shown in Table 5.

Production of Pigment-Dispersing Component A7

Using Pigment Red 122 (a dimethyl quinacridone pigment manufactured by Clariant) as a material, pigment-dispersing component A7 was produced by the method used to produce pigment-dispersing component A6. The particle diameter was measured by the method used in Example A-1 to be 80 nm.

### (2) Preparation of a Liquid Composition for Making Pigment Fixed

A liquid composition for making pigment fixed was prepared by mixing emulsion AJ obtained in Example A-6 with the vehicle components shown in Table 6.

### (3) Method for Producing Ink-Jet-Recorded Matter on a Fabric

Using the ink and liquid composition for making pigment fixed of Example A-7, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 4.

### (5) Measurement of Discharge Stability

The ink of Example A-7 was assessed for discharge stability by the method and evaluation criteria used in Example A-1. The result of discharge stability measurement is shown in Table 4.

### Example A-8

### (1) Preparation of an Ink for Ink Jet Recording

An ink for ink jet recording was prepared by producing pigment-dispersing component A8 by the method described below and then mixing it with the vehicle components shown in Table 5.

Production of Pigment-Dispersing Component A8

Using Pigment Yellow 180 (a benzimidazolone disazo pigment manufactured by Clariant) as a material, pigment-dispersing component A8 was produced by the method used to produce pigment-dispersing component A6. The particle diameter was measured by the method used in Example A-1 to be 130 nm.

### (2) Preparation of a Liquid Composition for Making Pigment Fixed

A liquid composition for making pigment fixed was prepared by mixing emulsion AJ obtained in Example A-6 with the vehicle components shown in Table 6.

### (3) Method for Producing Ink-Jet-Recorded Matter on a Fabric

Using the ink and liquid composition for making pigment fixed of Example A-8, sample ink-jet-recorded matter on a fabric was produced by the method used in Example A-1.

### (4) Tests for Resistance to Rubbing and Dry-Cleanability

The obtained sample (ink-jet-recorded matter on a fabric) was subjected to the tests for resistance to rubbing and dry-cleanability conducted in Example A-1. The results are shown in Table 4.

### (5) Measurement of Discharge Stability

The ink of Example A-8 was assessed for discharge stability by the method and evaluation criteria used in Example A-1. The result of discharge stability measurement is shown in Table 4.

### Reference Example A-7

In Reference Example A-7, liquid compositions for making pigment fixed were prepared by the method used in Example A-5, except that the polymer fine particles had a molecular weight of 90000 or 1100000. The emulsion having a molecular weight of 90000 was designated as emulsion AK (EM-AK), whereas the emulsion having a molecular weight of 1100000 was designated as emulsion AL (EM-AL). The ingredients of the liquid compositions for making pigment fixed are shown in Table 6. Also, the inks of Reference Example A-7 were conditioned using the pigment-dispersing component used in Example A-5. The composition of the inks is shown in Table 5. The sample ink-jet-recorded matter on a fabric was conditioned by the method used in Example A-1, and the obtained samples were subjected to the tests for resistance to rubbing, dry-cleanability, and discharge stability conducted in Example A-1. The results are shown in Table 4.

### Reference Example A-8

In Reference Example A-8, an ink and a liquid composition for making pigment fixed were prepared by the methods used in Example A-6, except that 1,2-hexanediol, which was used as an 1,2-alkylene glycol, was changed to glycerin. The composition of the ink is shown in Table 5, and the ingredients of the liquid composition for making pigment fixed are shown in Table 6. The sample ink-jet-recorded matter on a fabric was conditioned by the method used in Example A-1, and the obtained sample was subjected to the tests for resistance to rubbing, dry-cleanability, and discharge stability conducted in Example A-1. The results are shown in Table 4.

### Reference Example A-9

In Reference Example A-9, an ink and a liquid composition for making pigment fixed were prepared by the methods used in Example A-7, except that 1,2-hexanediol, which was used as an 1,2-alkylene glycol, was changed to glycerin. The composition of the ink is shown in Table 5, and the ingredients of the liquid composition for making pigment fixed are shown in Table 6. The sample ink-jet-recorded matter on a fabric was conditioned by the method used in Example A-1, and the obtained sample was subjected to the tests for resistance to rubbing, dry-cleanability, and discharge stability conducted in Example A-1. The results are shown in Table 4.

### Reference Example A-10

In Reference Example A-10, inks and liquid compositions for making pigment fixed were prepared by the methods used in Example A-8, except that the content ratio of the polymer fine particles was 80% or 50% relative to the respective liquid compositions for making pigment fixed. The composition of the inks is shown in Table 5, and the liquid compositions for making pigment fixed are shown in Table 6. The sample ink-jet-recorded matter on a fabric was conditioned by the method used in Example A-1, and the obtained samples were subjected to the tests for resistance to rubbing, dry-cleanability, and discharge stability conducted in Example A-1. The results are shown in Table 4.

### Reference Examples A-11 to A-15

Reference Examples A-11 to A-15 were equivalent to Example A-6 but were assessed for resistance to rubbing under different conditions from those used in Example A-6, more specifically, under various conditions other than heating the sample fabric having a solid image printed thereon at 150° C. for five minutes. Table 7 compares the results of the test for resistance to rubbing between Example A-6 and Reference Examples A-11 to A-15.

TABLE 4
Results of Resistance to Rubbing, Dry-cleanability, and Discharge Stability
Obtained from Examples A-5 to A-8 and Reference Examples A-7 to A-10

| | | | | | Content | | | | |
|---|---|---|---|---|---|---|---|---|---|
| | | | | | ratio | | | | |
| | | | | | relative | Resistance | | | |
| | | Particle | Acid | Molecular | to | to rubbing | | Dry- | Discharge |
| | Tg | diameter | value | weight | pigment | Dry | Wet | cleanability | stability |
| Example A-5 | −19 | 120 | 18 | 1.8 | 120 | 4 | 4 | 5 | A |
| Example A-6 | −21 | 100 | 18 | 2.0 | 150 | 5 | 5 | 5 | A |
| Example A-7 | −21 | 80 | 18 | 2.0 | 100 | 5 | 5 | 5 | A |
| Example A-8 | −21 | 130 | 18 | 2.0 | 120 | 5 | 5 | 5 | A |
| Reference | −19 | 120 | 18 | 0.9 | 120 | 3 | 3 | 2 | A |
| Example A-7 | −19 | 120 | 18 | 11.0 | 120 | 3 | ⅔ | 3 | D |
| Reference | −21 | 100 | 18 | 2.0 | 150 | 5 | ⅘ | 5 | C |
| Example A-8 | | | | | | | | | |
| Reference | −21 | 80 | 18 | 2.0 | 100 | ⅘ | ⅘ | 5 | C |
| Example A-9 | | | | | | | | | |
| Reference | −21 | 130 | 18 | 2.0 | 80 | ¾ | ¾ | 3 | A |
| Example A- | −21 | 130 | 18 | 2.0 | 50 | ⅔ | ⅔ | 2 | A |
| 10 | | | | | | | | | |

The unit of Tg is ° C.;
the particle diameter is an average particle diameter of the pigment in nm; and
the unit of the acid value is mg KOH/g.
The unit of the molecular weights in Table 4 is 10⁵.
The content ratio relative to pigment is the percentage content of the polymer fine particles relative to the pigment.
The resistance to rubbing and dry-cleanability were evaluated in accordance with JIS acceptance criteria.

TABLE 5
Composition of Inks of Examples A-5 to A-8 and Reference Examples A-7 to A-10
(wt %)

| | Example | | | | Reference Example | | | | | |
|---|---|---|---|---|---|---|---|---|---|---|
| | A-5 | A-6 | A-7 | A-8 | A-7 | | A-8 | A-9 | A-10 | |
| Dispersion component A5 | 4.0 | — | — | — | 4.0 | 4.0 | — | — | — | — |
| Dispersion component A6 | — | 3.2 | — | — | — | — | 3.2 | — | — | — |
| Dispersion component A7 | — | — | 4.0 | — | — | — | — | 4.0 | — | — |
| Dispersion component A8 | — | — | — | 4.0 | — | — | — | — | 4.0 | 4.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerin | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion-exchange water | Balance | Balance | Balance | Balance | Balance | Balance | Balance | Balance | Balance | Balance |

The concentrations of the pigments are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

TABLE 6
Ingredients of Liquid Compositions for Making Pigment Fixed of Examples A-5 to
A-8 and Reference Examples A-7 to A-10 (wt %)

| | Example | | | | Reference Example | | | | | |
|---|---|---|---|---|---|---|---|---|---|---|
| | A-5 | A-6 | A-7 | A-8 | A-7 | | A-8 | A-9 | A-10 | |
| EM-AI | 5.0 | — | — | — | — | — | — | — | — | — |
| EM-AJ | — | 4.8 | 4.0 | 5.0 | — | — | 4.8 | 4.0 | 3.2 | 2 |
| EM-AK | — | — | — | — | 5.0 | — | — | — | — | — |
| EM-AL | — | — | — | — | — | 5.0 | — | — | — | — |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerin | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion-exchange water | Balance | Balance | Balance | Balance | Balance | Balance | Balance | Balance | Balance | Balance |

The concentrations of the polymers are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

TABLE 7
Results of Test for Resistance to Rubbing with Example A-6 under
Various Conditions

| | | | Resistance | | |
|---|---|---|---|---|---|
| | Temperature | Time | to rubbing | | |
| | (° C.) | (min.) | Dry | Wet | Description |
| Example A-6 | 150 | 5 | 5 | 5 | Normal |
| Reference | 100 | 5 | 3 | 3 | Normal |
| Example A-11 | | | | | |
| Reference | 150 | 0.5 | 3 | 3 | Normal |
| Example A-12 | | | | | |
| Reference | 210 | 5 | 4 | 4 | Fabric yellowed |
| Example A-13 | | | | | |
| Reference | 210 | 1 | 4 | 4 | Fabric yellowed |
| Example A-14 | | | | | |
| Reference | 100 | 20 | 3 | 3 | Normal |
| Example A-15 | | | | | |

### Example B-1)

### (1) Preparation of an Ink for Ink Jet Recording

An ink for ink jet recording was prepared by producing pigment-dispersing component B1 by the method described later and then mixing it with the vehicle components shown in Table 9. Note that “ion-exchange water (balance)” presented in the composition of the inks of this example, other examples, comparative examples, and reference examples included in Examples B contained Topside 240 (manufactured by Permachem Asia, Ltd.) for preventing the corrosion of the ink at 0.05%, benzotriazol for preventing the corrosion of an ink jet head at 0.02%, and EDTA (ethylene diamine tetraacetic acid).2Na for reducing the influence of metal ions existing in the ink at 0.04%.

Production of Pigment-Dispersing Component B1

As a material of pigment-dispersing component B1, MONARCH 880, a carbon black (Pigment Black 7) manufactured by Cabot Corporation in the United States, was used. According to the method described in Japanese Unexamined Patent Application Publication No. H8-3498, the surface of the carbon black was oxidized so that the carbon black may be dispersed in water, and the obtained product was designated as dispersion component B1. The particle diameter was determined using Microtrac UPA250 Particle Size Analyzer (manufactured by Nikkiso Co., Ltd.) to be 110 nm.

### (2) Preparation of a Liquid Composition for Making Pigment Fixed

A liquid composition for making pigment fixed was prepared by producing the aqueous emulsion of polymer fine particles (emulsion BA) by the method described later and then mixing it with the vehicle components shown in Table 10. Note that “ion-exchange water (balance)” presented in the composition of the liquid compositions for making pigment fixed in this example, other examples, comparative examples, and reference examples included in Examples B contained Topside 240 (manufactured by Permachem Asia, Ltd.) for preventing the corrosion of the ink at 0.05%, benzotriazol for preventing the corrosion of an ink jet head at 0.02%, and EDTA (ethylene diamine tetraacetic acid).2Na for reducing the influence of metal ions existing in the ink at 0.04%.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.2 parts of potassium persulfate, a polymerization initiator, was added thereto. Separately, a monomer solution was prepared by mixing 7 parts of ion-exchange water with 0.05 part of sodium lauryl sulfate, 4 parts of glycidoxy acrylate, 15 parts of ethyl acrylate, 15 parts of butyl acrylate, 6 parts of ricinol oxazoline (meth)acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 30 parts of ethyl acrylate, 25 parts of methyl acrylate, 6 parts of ricinol oxazoline acrylate, 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion BA (EM-BA). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −15° C. Then, the styrene-based molecular weight of the polymer fine particle was measured by gel permeation chromatography (GPC) using L7100 System manufactured by Hitachi, Ltd. and THF as solvent. The styrene-based molecular weight was 150000. Subsequently, the acid value was measured by titration to be 20 mg KOH/g.

### (3) Method for Producing Ink-Jet-Recorded Matter on a Fabric

Using the ink described above, a solid image was printed on a fabric. The ink jet printer used was PX-V600 manufactured by Seiko Epson Corporation. On the obtained print, a solid image was printed using the liquid composition for making pigment fixed and the same printer.

The obtained print was heated at 150° C. for five minutes to obtain sample ink-jet-recorded matter on a fabric.

### (4) Tests for Resistance to Rubbing and Dry-Cleanability

The obtained sample (ink-jet-recorded matter on a fabric) was subjected to resistance to rubbing, in which the sample was rubbed 200 times with a load of 300 g using a color fastness rubbing tester AB-301S manufactured by Tester Sangyo Co., Ltd. Detachment of the ink was evaluated after two types of rubbing, namely dry rubbing and wet rubbing, in accordance with Japanese Industrial Standards (JIS) JIS L0849. Furthermore, the dry-cleanability was tested and evaluated in accordance with Method B of JIS L0860. The results of the tests for resistance to rubbing and dry-cleanability are shown in Table 8.

### (5) Measurement of Discharge Stability

Using PX-V600, an ink jet printer manufactured by Seiko Epson Corporation, and the ink composition for ink jet recording, letters were printed on Xerox P A4 paper manufactured by Fuji Xerox Co., Ltd. under the following conditions: atmosphere: 35° C./35%; software: Microsoft Word; font: 11 points of MS P Gothic with no additional styles; the number of letters: 4000 letters/page; and the number of pages: 100 pages. The result is shown in Table 8. The evaluation criteria were as follows: AA: no deformed letters; A: one deformed letter; B: two or three deformed letters; C: four or five deformed letters; and D: six or more deformed letters.

### Example B-2

### (1) Preparation of an Ink for Ink Jet Recording

An ink for ink jet recording was prepared by producing pigment-dispersing component B2 by the method described below and then mixing it with the vehicle components shown in Table 9.

Production of Pigment-Dispersing Component B2

As a material of pigment-dispersing component B2, Pigment Blue 15:3 (a copper phthalocyanine pigment manufactured by Clariant) was used. A stirrer, a thermometer, a reflux tube, and a dripping funnel were attached to a reaction vessel, and then the reaction vessel was filled with nitrogen. Into this reaction vessel, 75 parts of benzyl acrylate, 2 parts of acrylic acid, and 0.3 part of t-dodecylmercaptan were put, and then the reaction vessel was heated to 70° C. Separately, 150 parts of benzyl acrylate, 15 parts of acrylic acid, 5 parts of butyl acrylate, 1 part of t-dodecylmercaptan, 20 parts of methyl ethyl ketone, and 1 part of sodium persulfate were put into the dripping funnel. The content of the dripping funnel was dropped in the reaction vessel for four hours to polymerize dispersing polymer molecules. Subsequently, methyl ethyl ketone was added to the reaction vessel to prepare a 40% dispersive-polymer solution. A portion of this polymer was dried and then subjected to the measurement of glass transition temperature using a differential operation calorimeter (EXSTAR6000DSC manufactured by Seiko Instruments, Inc.). The glass transition temperature was 40° C.

Then, 40 parts of the dispersive-polymer solution was mixed with 30 parts of Pigment Blue 15:3, 100 parts of a 0.1 mol/L sodium hydroxide solution, and 30 parts of methyl ethyl ketone. The obtained mixture was put into an ultrahigh-pressure homogenizer (Ultimizer HJP-25005 manufactured by Sugino Machine Limited) and allowed to pass the homogenizer 15 times at 200 MPa so as to be dispersed. The obtained dispersion solution was transferred to another vessel, 300 parts of ion-exchange water was added thereto, and then the content of the vessel was stirred for one hour. Using a rotary evaporator, the entire volume of methyl ethyl ketone and a portion of water were distilled away. The residue was neutralized with a 0.1 mol/L sodium hydroxide until pH thereof was 9. The obtained product was filtered through a 0.3-μm membrane filter and conditioned by adding ion-exchange water until the pigment concentration was 15%. The obtained product was designated as pigment-dispersing component B2. The particle diameter was measured by the method used in Example B-1 to be 80 nm.

### (2) Preparation of a Liquid Composition for Making Pigment Fixed

A liquid composition for making pigment fixed was prepared by producing the aqueous emulsion of polymer fine particles (emulsion BB) by the method described later and then mixing it with the vehicle components shown in Table 10.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.2 parts of potassium persulfate, a polymerization initiator, was added thereto. Separately, a monomer solution was prepared by mixing 7 parts of ion-exchange water with 0.05 part of sodium lauryl sulfate, 19 parts of ethyl acrylate, 15 parts of butyl acrylate, 6 parts of ricinol oxazoline (meth)acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 30 parts of ethyl acrylate, 25 parts of methyl acrylate, 10 parts of butyl acrylate, 6 parts of ricinol oxazoline acrylate, 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion BB (EM-BB). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −17° C. Then, the molecular weight was measured by the method used in Example B-1 to be 200000. Subsequently, the acid value was measured by titration to be 20 mg KOH/g.

### (3) Method for Producing Ink-Jet-Recorded Matter on a Fabric

Using the ink and liquid composition for making pigment fixed of Example B-2, sample ink-jet-recorded matter on a fabric was produced by the method used in Example B-1.

### (4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 8.

### (5) Measurement of Discharge Stability

The ink of Example B-2 was assessed for discharge stability by the method and evaluation criteria used in Example B-1. The result of discharge stability measurement is shown in Table 8.

### Example B-3

### (1) Preparation of an Ink for Ink Jet Recording

An ink for ink jet recording was prepared by producing pigment-dispersing component B3 by the method described below and then mixing it with the vehicle components shown in Table 9.

Production of Pigment-Dispersing Component B3

As a material of pigment-dispersing component B3, Pigment Violet 19 (a quinacridone pigment manufactured by Clariant) was used. The production method was the same as that used to produce pigment-dispersing component B2. The particle diameter was measured by the method used in Example B-1 to be 90 nm.

### (2) Preparation of a Liquid Composition for Making Pigment Fixed

A liquid composition for making pigment fixed was prepared by mixing emulsion BB obtained in Example B-2 with the vehicle components shown in Table 10.

### (3) Method for Producing Ink-Jet-Recorded Matter on a Fabric

Using the ink and liquid composition for making pigment fixed of Example B-3, sample ink-jet-recorded matter on a fabric was produced by the method used in Example B-1.

### (4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 8.

### (5) Measurement of Discharge Stability

The ink of Example B-3 was assessed for discharge stability by the method and evaluation criteria used in Example B-1. The result of discharge stability measurement is shown in Table 8.

### Example B-4

### (1) Preparation of an Ink for Ink Jet Recording

An ink for ink jet recording was prepared by producing pigment-dispersing component B4 by the method described below and then mixing it with the vehicle components shown in Table 9.

Production of Pigment-Dispersing Component B4

As a material of pigment-dispersing component B4, Pigment Yellow 14 (an azo pigment manufactured by Clariant) was used. The production method was the same as that used to produce pigment-dispersing component B2. The particle diameter was measured by the method used in Example B-1 to be 115 nm.

### (2) Preparation of a Liquid Composition for Making Pigment Fixed

A liquid composition for making pigment fixed was prepared by mixing emulsion BB obtained in Example B-2 with the vehicle components shown in Table 10.

### (3) Method for Producing Ink-Jet-Recorded Matter on a Fabric

Using the ink and liquid composition for making pigment fixed of Example B-4, sample ink-jet-recorded matter on a fabric was produced by the method used in Example B-1.

(4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 8.

(5) Measurement of Discharge Stability

The ink of Example B-4 was assessed for discharge stability by the method and evaluation criteria used in Example B-1. The result of discharge stability measurement is shown in Table 8.

### Comparative Example B-1

In Comparative Example B-1, a liquid composition for making pigment fixed was conditioned by the method used in Example B-1, except that, in preparing polymer fine particles, the entire volume (45 parts) of ethyl acrylate was changed to 45 parts of benzyl methacrylate so that the polymer fine particles may have had a glass transition temperature of 0° C. The emulsion produced using these polymer fine particles was designated as emulsion BC (EM-BC). The ingredients of the liquid composition for making pigment fixed are shown in Table 10. Also, the ink of Comparative Example B-1 was conditioned using the pigment-dispersing component used in Example B-1. The composition of the ink is shown in Table 9. The sample ink-jet-recorded matter on a fabric was conditioned by the method used in Example B-1, and the obtained sample was subjected to the tests for resistance to rubbing, dry-cleanability, and discharge stability conducted in Example B-1. The results are shown in Table 8.

### Comparative Example B-2

In Comparative Example B-2, a liquid composition for making pigment fixed was prepared by the method used in Example B-2, except that, in preparing polymer fine particles, the entire volume (49 parts) of ethyl acrylate was changed to benzyl methacrylate and 10 parts of butyl acrylate was changed to 10 parts of benzyl methacrylate so that the polymer fine particles may have had a glass transition temperature of 10° C. The emulsion produced using these polymer fine particles was designated as emulsion BD (EM-BD). The ingredients of the liquid composition for making pigment fixed are shown in Table 9. Also, the ink of Comparative Example B-2 was conditioned using the pigment-dispersing component used in Example B-2. The composition of the ink is shown in Table 9. The sample ink-jet-recorded matter on a fabric was conditioned by the method used in Example B-1, and the obtained sample was subjected to the tests for resistance to rubbing, dry-cleanability, and discharge stability conducted in Example B-1. The results are shown in Table 8.

### Reference Example B-3

In Reference Example B-3, inks were prepared by the method used in Example B-3, except that pigment-dispersing components had a particle diameter of 350 nm or 45 nm. The particle diameter was measured by the method used in Example B-1. The pigment-dispersing component having a particle diameter of 350 nm was designated as pigment-dispersing component B3A, whereas the pigment-dispersing component having a particle diameter of 45 nm was designated as pigment-dispersing component B3B. The compositions of the inks are shown in Table 9. Note that the liquid compositions for making pigment fixed used in Reference Example B-3 are equivalent to that used in Example B-3. The ingredients of the liquid compositions for making pigment fixed are shown in Table 3. The sample ink-jet-recorded matter on a fabric was conditioned by the method used in Example B-1, and the obtained samples were subjected to the tests for resistance to rubbing, dry-cleanability, and discharge stability conducted in Example B-1. The results are shown in Table 8.

### Comparative Example B-4

In Comparative Example B-4, liquid compositions for making pigment fixed were prepared by the method used in Example B-4, except that the polymer fine particles had an acid value of 120 or 150 mg KOH/g. The emulsion produced using the polymer fine particles having an acid value of 120 mg KOH/g was designated as emulsion BE (EM-BE), whereas the emulsion produced using the polymer fine particles having an acid value of 150 mg KOH/g was designated as emulsion BF (EM-BF). The ingredients of the liquid compositions for making pigment fixed are shown in Table 10. Also, the inks of Comparative Example B-4 were equivalent to that of Example B-4. The compositions of the inks are shown in Table 9. The sample ink-jet-recorded matter on a fabric was conditioned by the method used in Example B-1, and the obtained samples were subjected to the tests for resistance to rubbing, dry-cleanability, and discharge stability conducted in Example B-1. The results are shown in Table 8.

### Comparative Example B-5

In Comparative Example B-5, a liquid composition for making pigment fixed was prepared by the method used in Example B-2, except that the compound having an ethylene-based unsaturated group and an oxazoline group (ricinol oxazoline (meth)acrylate) was excluded. The emulsion produced using polymer fine particles containing no compound having an ethylene-based unsaturated group and an oxazoline group (ricinol oxazoline (meth)acrylate) was designated as emulsion BG (EM-BG). The ingredients of the liquid composition for making pigment fixed are shown in Table 10. Also, the ink of Comparative Example B-5 was equivalent to that of Example B-2. The composition of the ink is shown in Table 9. The sample ink-jet-recorded matter on a fabric was conditioned by the method used in Example B-1, and the obtained sample was subjected to the tests for resistance to rubbing, dry-cleanability, and discharge stability conducted in Example B-1. The results are shown in Table 8.

### Comparative Example B-6

In Comparative Example B-6, a liquid composition for making pigment fixed was prepared by the method used in Example B-3, except that the compound having an ethylene-based unsaturated group and an oxazoline group (ricinol oxazoline (meth)acrylate) was excluded. The ingredients of the liquid composition for making pigment fixed are shown in Table 10. Also, the ink of Comparative Example B-6 was equivalent to that of Example B-3. The composition of the ink is shown in Table 9. The sample ink-jet-recorded matter on a fabric was conditioned by the method used in Example B-1, and the obtained sample was subjected to the tests for resistance to rubbing, dry-cleanability, and discharge stability conducted in Example B-1. The results are shown in Table 8.

TABLE 8
Results of Resistance to Rubbing, Dry-cleanability, and Discharge
Stability Obtained from Examples B-1 to B-4, Comparative Examples
B-1, B-2, and B-4 to B-6, and Reference Example B-3

| | | | | Resistance | | Dry- | Dis- |
|---|---|---|---|---|---|---|---|
| | | Particle | Acid | to rubbing | | cleana- | charge |
| | Tg | diameter | value | Dry | Wet | bility | stability |
| Example B-1 | −15 | 110 | 20 | ¾ | ¾ | ⅘ | A |
| Example B-2 | −17 | 80 | 20 | 5 | ⅘ | 5 | A |
| Example B-3 | −17 | 90 | 20 | 5 | 5 | 5 | A |
| Example B-4 | −17 | 115 | 20 | 5 | 5 | 5 | A |
| Comparative | 0 | 110 | 20 | 3 | 2 | ⅔ | A |
| Example B-1 | | | | | | | |
| Comparative | 10 | 80 | 20 | ⅔ | ⅔ | 2 | A |
| Example B-2 | | | | | | | |
| Reference | −17 | 350 | 20 | 2 | 2 | ⅔ | D |
| Example B-3 | −17 | 45 | 20 | ¾ | ¾ | 4 | C |
| Comparative | −17 | 115 | 120 | 3 | 3 | 3 | A |
| Example B-4 | −17 | 115 | 150 | ⅔ | ⅔ | ¾ | A |
| Comparative | −17 | 80 | 20 | 2 | ½ | 5 | A |
| Example B-5 | | | | | | | |
| Comparative | −17 | 90 | 20 | 3 | ⅔ | 5 | A |
| Example B-6 | | | | | | | |

The unit of Tg is ° C.;
the particle diameter is an average particle diameter of the pigment in nm; and
the unit of the acid value is mg KOH/g.
The resistance to rubbing and dry-cleanability were evaluated in accordance with JIS acceptance criteria.

TABLE 9
Composition of Inks of Examples B-1 to B-4, Comparative Examples B-1, B-2, and
B-4 to B-6, and Reference Example B-3 (wt %)

| | | | | | Comparative | | Reference | | Comparative | | | |
|---|---|---|---|---|---|---|---|---|---|---|---|---|
| | Example | | | | Example | | Example | | Example | | | |
| | B-1 | B-2 | B-3 | B-4 | B-1 | B-2 | B-3 | | B-4 | | B-5 | B-6 |
| Dispersion | 4.5 | — | — | — | 4.5 | — | — | — | — | — | — | — |
| component B1 | | | | | | | | | | | | |
| Dispersion | — | 3.5 | — | — | — | 3.5 | — | — | — | — | 3.5 | — |
| component B2 | | | | | | | | | | | | |
| Dispersion | — | — | 4.5 | — | — | — | — | — | — | — | — | 4.5 |
| component B3 | | | | | | | | | | | | |
| Dispersion | — | — | — | 4.5 | — | — | — | — | 4.5 | 4.5 | — | — |
| component B4 | | | | | | | | | | | | |
| Dispersion | — | — | — | — | — | — | 4.5 | — | — | — | — | — |
| component B3A | | | | | | | | | | | | |
| Dispersion | — | — | — | — | — | — | — | 4.5 | — | — | — | — |
| component B3B | | | | | | | | | | | | |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerin | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion-exchange | Balance | Balance | Balance | Balance | Balance | Balance | Balance | Balance | Balance | Balance | Balance | Balance |
| water | | | | | | | | | | | | |

The concentrations of the pigments are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

TABLE 10
Ingredients of Liquid Compositions for Making Pigment Fixed of Examples B-1
to B-4, Comparative Examples B-1, B-2, and B-4 to B-6, and Reference Example B-3 (wt %)

| | | | | | Comparative | | Reference | | Comparative | | | |
|---|---|---|---|---|---|---|---|---|---|---|---|---|
| | Example | | | | Example | | Example | | Example | | | |
| | B-1 | B-2 | B-3 | B-4 | B-1 | B-2 | B-3 | | B-4 | | B-5 | B-6 |
| EM-BA | 6.0 | — | — | — | — | — | — | — | — | — | — | — |
| EM-BB | — | 5.0 | 6.0 | 6.0 | — | — | 6.0 | 6.0 | — | — | — | — |
| EM-BC | — | — | — | — | 6.0 | — | — | — | — | — | — | — |
| EM-BD | — | — | — | — | — | 6.0 | — | — | — | — | — | — |
| EM-BE | — | — | — | — | — | — | — | — | 6.0 | — | — | — |
| EM-BF | — | — | — | — | — | — | — | — | — | 6.0 | — | — |
| EM-BG | — | — | — | — | — | — | — | — | — | — | 5.0 | 6.0 |
| 1,2-HD | 2.0 | 3.0 | 3.0 | 2.0 | 2.0 | 3.0 | 3.0 | 3.0 | 2.0 | 2.0 | 3.0 | 3.0 |
| 1,2-PD | — | — | — | 1.0 | — | — | — | — | 1.0 | 1.0 | — | — |
| TEGmBE | 2.0 | 1.0 | 1.0 | 2.0 | 2.0 | 1.0 | 1.0 | 1.0 | 2.0 | 2.0 | 1.0 | 1.0 |
| S-104 | 0.3 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.5 | 0.5 | 0.5 | 0.3 | 0.3 | 0.5 | 0.5 | 0.5 | 0.3 |
| S-61 | — | — | 0.2 | — | — | — | 0.2 | 0.2 | — | — | — | 0.2 |
| Glycerin | 10.0 | 12.0 | 10.0 | 10.0 | 10.0 | 12.0 | 10.0 | 10.0 | 10.0 | 10.0 | 12.0 | 10.0 |
| TMP | 3.0 | 3.0 | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 | 5.0 | 4.0 |
| 2-P | 1.0 | — | — | — | 1.0 | — | — | — | — | — | — | — |
| TEA | 1.0 | 1.0 | 1.0 | 1.0 | 1.0 | 1.0 | 1.0 | 1.0 | 1.0 | 1.0 | 1.0 | 1.0 |
| Ion-exchange | Balance | Balance | Balance | Balance | Balance | Balance | Balance | Balance | Balance | Balance | Balance | Balance |
| water | | | | | | | | | | | | |

The concentrations of the polymers are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

### Example B-5

### (1) Preparation of an Ink for Ink Jet Recording

An ink for ink jet recording was prepared by producing pigment-dispersing component B5 by the method described below and then mixing it with the vehicle components shown in Table 12.

Production of Pigment-Dispersing Component B5

As a material of pigment-dispersing component B5, MA100 manufactured by Mitsubishi Chemical Industries Corporation, a carbon black (PBk7), was used. According to the method described in Japanese Unexamined Patent Application Publication No. H8-3498, the surface of the carbon black was oxidized so that the carbon black may be dispersed in water, and the obtained product was designated as dispersion component B5. The particle diameter was measured by the method used in Example B-1 to be 120 nm.

### (2) Preparation of a Liquid Composition for Making Pigment Fixed

A liquid composition for making pigment fixed was prepared by producing the aqueous emulsion of polymer fine particles (emulsion BI) by the method described later and then mixing it with the vehicle components shown in Table 13.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.3 parts of potassium persulfate, a polymerization initiator, was added thereto. Separately, a monomer solution was prepared by mixing 7 parts of ion-exchange water with 0.05 part of sodium lauryl sulfate, 20 parts of ethyl acrylate, 15 parts of butyl acrylate, 6 parts of lauryl acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 30 parts of ethyl acrylate, 25 parts of butyl acrylate, 10 parts of lauryl acrylate, 6 parts of ricinol oxazoline methacrylate, 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion BI (EM-BI). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −17° C. Then, the molecular weight of the polymer fine particle was measured by the method used in Example B-1. The molecular weight was 180000. Subsequently, the acid value was measured by titration to be 18 mg KOH/g.

### (3) Method for Producing Ink-Jet-Recorded Matter on a Fabric

Using the ink and liquid composition for making pigment fixed of Example B-5, sample ink-jet-recorded matter on a fabric was produced by the method used in Example B-1.

### (4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 11.

### (5) Measurement of Discharge Stability

The ink of Example B-5 was assessed for discharge stability by the method and evaluation criteria used in Example B-1. The result of discharge stability measurement is shown in Table 11.

### Example B-6

### (1) Preparation of an Ink for Ink Jet Recording

An ink for ink jet recording was prepared by producing pigment-dispersing component B6 by the method described below and then mixing it with the vehicle components shown in Table 12.

Production of Pigment-Dispersing Component B6

As a material of pigment-dispersing component B6, Pigment Blue 15:3 (a copper phthalocyanine pigment manufactured by Clariant) was used. A stirrer, a thermometer, a reflux tube, and a dripping funnel were attached to a reaction vessel, and then the reaction vessel was filled with nitrogen. Into this reaction vessel, 45 parts of styrene, 30 parts of polyethylene glycol 400 acrylate, 10 parts of benzyl acrylate, 2 parts of acrylic acid, and 0.3 part of t-dodecylmercaptan were put, and then the reaction vessel was heated to 70° C. Separately, 150 parts of styrene, 100 parts of polyethylene glycol 400 acrylate, 15 parts of acrylic acid, 5 parts of butyl acrylate, 1 part of t-dodecylmercaptan, and 5 part of sodium persulfate were put into the dripping funnel. The content of the dripping funnel was dropped in the reaction vessel for four hours to polymerize dispersing polymer molecules. Subsequently, water was added to the reaction vessel to prepare a 40% dispersive-polymer solution. A portion of this polymer was dried and then subjected to the measurement of glass transition temperature using a differential operation calorimeter (EXSTAR6000DSC manufactured by Seiko Instruments, Inc.). The glass transition temperature was 45° C.

Then, 40 parts of the dispersive-polymer solution was mixed with 30 parts of Pigment Blue 15:3 (a copper phthalocyanine pigment manufactured by Clariant) and 100 parts of a 0.1 mol/L sodium hydroxide solution. The obtained mixture was dispersed for two hours using an Eiger mill containing zirconia beads. The obtained dispersion solution was transferred to another vessel, 300 parts of ion-exchange water was added thereto, and then the content of the vessel was stirred for one hour. The content of the vessel was neutralized with a 0.1 mol/L sodium hydroxide until pH thereof was 9. The product was filtered through a 0.3-μm membrane filter, and thus dispersion component B5 containing solid content (the dispersive polymer and Pigment Blue 15:3) at 20%. The particle diameter was measured by the method used in Example B-1 to be 100 nm. The molecular weight was measured to be 210000.

### (2) Preparation of a Liquid Composition for Making Pigment Fixed

A liquid composition for making pigment fixed was prepared by producing the aqueous emulsion of polymer fine particles (emulsion BJ) by the method described later and then mixing it with the vehicle components shown in Table 13.

Production of Polymer Fine Particles

A dripper, a thermometer, a water-cooled reflux condenser, and a stirrer were attached to a reaction vessel, 100 parts of ion-exchange water was put into the reaction vessel. The water was stirred under nitrogen at 70° C., while 0.3 parts of potassium persulfate, a polymerization initiator, was added thereto. Separately, a monomer solution was prepared by mixing 7 parts of ion-exchange water with 0.05 part of sodium lauryl sulfate, 20 parts of ethyl acrylate, 25 parts of butyl acrylate, 6 parts of lauryl acrylate, 5 parts of butyl methacrylate, and 0.02 part of t-dodecylmercaptan. This monomer solution was dropped in the reaction vessel at 70° C. to produce a primary product. This primary product was stirred after 2 parts of a 10% ammonium persulfate solution was added thereto. Separately, a reaction solution was prepared by mixing 30 parts of ion-exchange water with 0.2 part of potassium lauryl sulfate, 20 parts of ethyl acrylate, 20 parts of butyl acrylate, 14 parts of lauryl acrylate, 6 parts of ricinol oxazoline methacrylate, 5 parts of acrylic acid, and 0.5 part of t-dodecylmercaptan. While the primary product was stirred at 70° C., the reaction solution was added to the primary product to initiate polymerization. After the completion of polymerization, the resultant emulsion was neutralized with sodium hydroxide until pH thereof was in the range of 8 to 8.5, and then the neutralized emulsion was filtered through a 0.3-μm filter. The obtained aqueous emulsion of polymer fine particles was designated as emulsion BJ (EM-BJ). A portion of this aqueous emulsion of polymer fine particles was dried and then subjected to the measurement of glass transition temperature using a differential operation calorimeter (EXSTAR6000DSC manufactured by Seiko Instruments, Inc.). The glass transition temperature was −18° C. Subsequently, the acid value was measured by titration to be 18 mg KOH/g.

### (3) Method for Producing Ink-Jet-Recorded Matter on a Fabric

Using the ink and liquid composition for making pigment fixed of Example B-6, sample ink-jet-recorded matter on a fabric was produced by the method used in Example B-1.

### (4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 11.

### (5) Measurement of Discharge Stability

The ink of Example B-6 was assessed for discharge stability by the method and evaluation criteria used in Example B-1. The result of discharge stability measurement is shown in Table 11.

### Example B-7

### (1) Preparation of an Ink for Ink Jet Recording

An ink for ink jet recording was prepared by producing pigment-dispersing component B7 by the method described below and then mixing it with the vehicle components shown in Table 12.

Production of Pigment-Dispersing Component B7

Using Pigment Red 122 (a dimethyl quinacridone pigment manufactured by Clariant) as a material, pigment-dispersing component B7 was produced by the method used to produce pigment-dispersing component B6. The particle diameter was measured by the method used in Example B-1 to be 80 nm.

### (2) Preparation of a Liquid Composition for Making Pigment Fixed

A liquid composition for making pigment fixed was prepared by mixing emulsion BJ obtained in Example B-6 with the vehicle components shown in Table 13.

### (3) Method for Producing Ink-Jet-Recorded Matter on a Fabric

Using the ink and liquid composition for making pigment fixed of Example B-7, sample ink-jet-recorded matter on a fabric was produced by the method used in Example B-1.

### (4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 11.

### (5) Measurement of Discharge Stability

The ink of Example B-7 was assessed for discharge stability by the method and evaluation criteria used in Example B-1. The result of discharge stability measurement is shown in Table 11.

### Example B-8

### (1) Preparation of an Ink for Ink Jet Recording

An ink for ink jet recording was prepared by producing pigment-dispersing component BB by the method described below and then mixing it with the vehicle components shown in Table 12.

Production of Pigment-Dispersing Component B8

Using Pigment Yellow 180 (a benzimidazolone disazo pigment manufactured by Clariant) as a material, pigment-dispersing component B8 was produced by the method used to produce pigment-dispersing component B6. The particle diameter was measured by the method used in Example B-1 to be 130 nm.

### (2) Preparation of a Liquid Composition for Making Pigment Fixed

A liquid composition for making pigment fixed was prepared by mixing emulsion BJ obtained in Example B-6 with the vehicle components shown in Table 13.

### (3) Method for Producing Ink-Jet-Recorded Matter on a Fabric

Using the ink and liquid composition for making pigment fixed of Example B-8, sample ink-jet-recorded matter on a fabric was produced by the method used in Example B-1.

### (4) Tests for Resistance to Rubbing and Dry-Cleanability

The obtained sample (ink-jet-recorded matter on a fabric) was subjected to the tests for resistance to rubbing and dry-cleanability conducted in Example B-1. The results are shown in Table 11.

### (5) Measurement of Discharge Stability

The ink of Example B-8 was assessed for discharge stability by the method and evaluation criteria used in Example B-1. The result of discharge stability measurement is shown in Table 11.

### Reference Example B-7

In Reference Example B-7, liquid compositions for making pigment fixed were prepared by the method used in Example B-5, except that the polymer fine particles had a molecular weight of 90000 or 1100000. The emulsion having a molecular weight of 90000 was designated as emulsion BK (EM-BK), whereas the emulsion having a molecular weight of 1100000 was designated as emulsion BL (EM-BL). The ingredients of the liquid compositions for making pigment fixed are shown in Table 13. Also, the inks of Reference Example B-7 were conditioned using the pigment-dispersing component used in Example B-5. The composition of the inks is shown in Table 12. The sample ink-jet-recorded matter on a fabric was conditioned by the method used in Example B-1, and the obtained samples were subjected to the tests for resistance to rubbing, dry-cleanability, and discharge stability conducted in Example B-1. The results are shown in Table 11.

### Reference Example B-8

In Reference Example B-8, an ink and a liquid composition for making pigment fixed were prepared by the methods used in Example B-6, except that 1,2-hexanediol, which was used as an 1,2-alkylene glycol, was changed to glycerin. The composition of the ink is shown in Table 12, and the ingredients of the liquid composition for making pigment fixed are shown in Table 13. The sample ink-jet-recorded matter on a fabric was conditioned by the method used in Example B-1, and the obtained sample was subjected to the tests for resistance to rubbing, dry-cleanability, and discharge stability conducted in Example B-1. The results are shown in Table 11.

### Reference Example B-9

In Reference Example B-9, an ink and a liquid composition for making pigment fixed were prepared by the methods used in Example B-7, except that 1,2-hexanediol, which was used as an 1,2-alkylene glycol, was changed to glycerin. The composition of the ink is shown in Table 12, and the ingredients of the liquid composition for making pigment fixed are shown in Table 13. The sample ink-jet-recorded matter on a fabric was conditioned by the method used in Example B-1, and the obtained sample was subjected to the tests for resistance to rubbing, dry-cleanability, and discharge stability conducted in Example B-1. The results are shown in Table 11.

### Reference Example B-10

In Reference Example B-10, inks and liquid compositions for making pigment fixed were prepared by the methods used in Example B-8, except that the content ratio of the polymer fine particles was 806 or 50% relative to the respective liquid compositions for making pigment fixed. The composition of the inks is shown in Table 12, and the liquid compositions for making pigment fixed are shown in Table 13. The sample ink-jet-recorded matter on a fabric was conditioned by the method used in Example B-1, and the obtained samples were subjected to the tests for resistance to rubbing, dry-cleanability, and discharge stability conducted in Example B-1. The results are shown in Table 11.

### Reference Examples B-11 to B-15

Reference Examples B-11 to B-15 were equivalent to Example B-6 but were assessed for resistance to rubbing under different conditions from those used in Example B-6, more specifically, under various conditions other than heating the sample fabric having a solid image printed thereon at 150° C. for five minutes. Table 14 compares the results of the test for resistance to rubbing between Example B-6 and Reference Examples B-11 to B-15.

TABLE 11
Results of Resistance to Rubbing, Dry-cleanability, and Discharge Stability
Obtained from Examples B-5 to B-8 and Reference Examples B-7 to B-10

| | | | | | Content | | | | |
|---|---|---|---|---|---|---|---|---|---|
| | | | | | ratio | | | | |
| | | | | | relative | Resistance | | | |
| | | Particle | Acid | Molecular | to | to rubbing | | Dry- | Discharge |
| | Tg | diameter | value | weight | pigment | Dry | Wet | cleanability | stability |
| Example B-5 | −19 | 120 | 18 | 1.8 | 120 | 4 | 4 | 5 | A |
| Example B-6 | −21 | 100 | 18 | 2.0 | 150 | 5 | 5 | 5 | A |
| Example B-7 | −21 | 80 | 18 | 2.0 | 100 | 5 | 5 | 5 | A |
| Example B-8 | −21 | 130 | 18 | 2.0 | 120 | 5 | 5 | 5 | A |
| Reference | −19 | 120 | 18 | 0.9 | 120 | 3 | 3 | 2 | A |
| Example B-7 | −19 | 120 | 18 | 11.0 | 120 | 3 | ⅔ | 3 | D |
| Reference | −21 | 100 | 18 | 2.0 | 150 | 5 | ⅘ | 5 | C |
| Example B-8 | | | | | | | | | |
| Reference | −21 | 80 | 18 | 2.0 | 100 | ⅘ | ⅘ | 5 | C |
| Example B-9 | | | | | | | | | |
| Reference | −21 | 130 | 18 | 2.0 | 80 | ¾ | ¾ | 3 | A |
| Example B- | −21 | 130 | 18 | 2.0 | 50 | ⅔ | ⅔ | 2 | A |
| 10 | | | | | | | | | |

The unit of Tg is ° C.;
the particle diameter is an average particle diameter of the pigment in nm; and
the unit of the acid value is mg KOH/g.
The unit of the molecular weights in Table 11 is 10⁵.
The content ratio relative to pigment is the percentage content of the polymer fine particles relative to the pigment.
The resistance to rubbing and dry-cleanability were evaluated in accordance with JIS acceptance criteria.

TABLE 12
Composition of Inks of Examples B-5 to B-8 and Reference Examples B-7 to B-10
(wt %)

| | Example | | | | Reference Example | | | | | |
|---|---|---|---|---|---|---|---|---|---|---|
| | B-5 | B-6 | B-7 | B-8 | B-7 | | B-8 | B-9 | B-10 | |
| Dispersion component B5 | 4.0 | — | — | — | 4.0 | 4.0 | — | — | — | — |
| Dispersion component B6 | — | 3.2 | — | — | — | — | 3.2 | — | — | — |
| Dispersion component B7 | — | — | 4.0 | — | — | — | — | 4.0 | — | — |
| Dispersion component B8 | — | — | — | 4.0 | — | — | — | — | 4.0 | 4.0 |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerin | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion-exchange water | Balance | Balance | Balance | Balance | Balance | Balance | Balance | Balance | Balance | Balance |

The concentrations of the pigments are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

TABLE 13
Ingredients of Liquid Compositions for Making Pigment Fixed of Examples B-5
to B-8 and Reference Examples B-7 to B-10 (wt %)

| | Example | | | | Reference Example | | | | | |
|---|---|---|---|---|---|---|---|---|---|---|
| | B-5 | B-6 | B-7 | B-8 | B-7 | | B-8 | B-9 | B-10 | |
| EM-BI | 5.0 | — | — | — | — | — | — | — | — | — |
| EM-BJ | — | 4.8 | 4.0 | 5.0 | — | — | 4.8 | 4.0 | 3.2 | 2 |
| EM-BK | — | — | — | — | 5.0 | — | — | — | — | — |
| EM-BL | — | — | — | — | — | 5.0 | — | — | — | — |
| 1,2-HD | 2.0 | 3.0 | 3.0 | 2.0 | 2.0 | 2.0 | — | 3.0 | 2.0 | 2.0 |
| 1,2-PD | — | — | — | 1.0 | — | — | — | — | 1.0 | 1.0 |
| TEGmBE | 2.0 | 1.0 | 1.0 | 2.0 | 2.0 | 2.0 | 1.0 | 1.0 | 2.0 | 2.0 |
| S-104 | 0.3 | 0.3 | 0.3 | 0.3 | 0.3 | 0.3 | 0.3 | — | 0.3 | 0.3 |
| S-465 | 0.5 | 0.5 | 0.3 | 0.5 | 0.5 | 0.5 | 0.3 | — | 0.5 | 0.5 |
| S-61 | — | — | 0.2 | — | — | — | 0.2 | — | — | — |
| Glycerin | 10.0 | 12.0 | 10.0 | 10.0 | 10.0 | 12.0 | 13.0 | 11.0 | 10.0 | 10.0 |
| TMP | 3.0 | 3.0 | 3.0 | 3.0 | 3.0 | 3.0 | 3.0 | 3.0 | 3.0 | 3.0 |
| TEG | 3.0 | 5.0 | 4.0 | 4.0 | 4.0 | 4.0 | 4.0 | 4.0 | 4.0 | 4.0 |
| 2-P | 1.0 | — | — | — | 1.0 | — | — | — | — | — |
| TEA | 1.0 | 1.0 | 1.0 | 1.0 | 1.0 | 1.0 | 1.0 | 1.0 | 1.0 | 1.0 |
| Ion-exchange water | Balance | Balance | Balance | Balance | Balance | Balance | Balance | Balance | Balance | Balance |

The concentrations of the polymers are solid content.
1,2-HD: 1,2-Hexanediol
1,2-PD: 1,2-Pentanediol
TEGmBE: Triethylene glycol monobutyl ether
S-104: Surfynol 104 (an acetylene-glycol-based surfactant manufactured by Nissin Chemical Industry Co., Ltd.)
S-465: Surfynol 465 (an acetylene-glycol-based surfactant manufactured by Nissin Chemical Industry Co., Ltd.)
S-61: Surfynol 61 (an acetylene-glycol-based surfactant manufactured by Nissin Chemical Industry Co., Ltd.)
TMP: Trimethylolpropane
TEG: Triethylene glycol
2-P: 2-Pyrrolidone
TEA: Triethanolamine

TABLE 14
Results of Test for Resistance to Rubbing with Example B-6 under
Various Conditions

| | | | Resistance | | |
|---|---|---|---|---|---|
| | Temperature | Time | to rubbing | | |
| | (° C.) | (min.) | Dry | Wet | Description |
| Example B-6 | 150 | 5 | 5 | 5 | Normal |
| Reference | 100 | 5 | 3 | 3 | Normal |
| Example B-11 | | | | | |
| Reference | 150 | 0.5 | 3 | 3 | Normal |
| Example B-12 | | | | | |
| Reference | 210 | 5 | 4 | 4 | Fabric yellowed |
| Example B-13 | | | | | |
| Reference | 210 | 1 | 4 | 4 | Fabric yellowed |
| Example B-14 | | | | | |
| Reference | 100 | 20 | 3 | 3 | Normal |
| Example B-15 | | | | | |

1. A liquid composition for making pigment fixed, comprising at least a polymer fine particle synthesized using an alkyl (meth)acrylate and/or cyclic alkyl (meth)acrylate and a reactive compound having an ethylene-based unsaturated group and a reactive group, a glass transition temperature and an acid value of the liquid composition being equal to or lower than −10° C. and equal to or lower than 100 mg KOH/g, respectively.

2. The liquid composition for making pigment fixed according to claim 1, wherein the reactive group is a block isocyanate and an oxazoline group.

3. The liquid composition for making pigment fixed according to claim 1, wherein a content ratio of the alkyl (meth)acrylate and/or cyclic alkyl (meth)acrylate relative to a total mass of the polymer fine particle is equal to or higher than 70 mass %.

4. The liquid composition for making pigment fixed according to claim 1, wherein the alkyl (meth)acrylate and/or cyclic alkyl (meth)acrylate is an alkyl (meth)acrylate having 1 to 24 carbon atoms and/or cyclic alkyl (meth)acrylate having 3 to 24 carbon atoms.

5. The liquid composition for making pigment fixed according to claim 1, wherein a styrene-based weight average molecular weight of the polymer fine particle measured by gel permeation chromatography (GPC) is in the range of 100000 to 1000000.

6. An ink set comprising an ink composition and the liquid composition for making pigment fixed according to claim 1, wherein:
the ink composition contains a dispersion component containing water and a pigment dispersed in the water.

7. The ink set according to claim 6, wherein the dispersion component has an average particle diameter in the range of 50 to 300 nm.

8. The ink set according to claim 7, wherein the dispersion component is a self-dispersing carbon black having an ability to be dispersed in water without a dispersant and an average particle diameter in the range of 50 to 300 nm.

9. The ink set according to claim 8, wherein the dispersion component contains water and an organic pigment dispersed in the water using a polymer and has an average particle diameter in the range of 50 to 300 nm, and a styrene-based weight average molecular weight of the polymer measured by gel permeation chromatography (GPC) is in the range of 10000 to 200000.

10. The ink set according to claim 6, wherein the ink composition contains a 1,2-alkylene glycol.

11. The ink set according to claim 6, wherein the ink composition contains an acetylene-glycol-based surfactant and/or acetylene-alcohol-based surfactant.

12. The ink set according to claim 6, wherein a content ratio of the polymer fine particle (mass %) is higher than a content ratio of the pigment (mass %).

13. A method for producing ink-jet-recorded matter on a fabric, comprising:
a step of printing an ink composition containing a dispersion component containing water and a pigment dispersed in the water on a fabric by ink jet;
a step of immersing the obtained print in the liquid composition for making pigment fixed according to claim 1; and
a step of heating the immersed print at a temperature in the range of 110 to 200° C. for at least one minute.

14. A method for producing ink-jet-recorded matter on a fabric, comprising:
a step of printing an ink composition containing a dispersion component containing water and a pigment dispersed in the water on a fabric by ink jet;
a step of applying the liquid composition for making pigment fixed according to claim 1 to the obtained print by ink jet; and
a step of heating the print with the liquid composition applied thereto at a temperature in the range of 110 to 200° C. for at least one minute.

15. The method for producing ink-jet-recorded matter on a fabric according to claim 13, wherein the dispersion component has an average particle diameter in the range of 50 to 300 nm.

16. The method for producing ink-jet-recorded matter on a fabric according to claim 15, wherein the dispersion component is a self-dispersing carbon black having an ability to be dispersed in water without a dispersant and an average particle diameter in the range of 50 to 300 nm.

17. The method for producing ink-jet-recorded matter on a fabric according to claim 15, wherein the dispersion component contains water and an organic pigment dispersed in the water using a polymer and has an average particle diameter in the range of 50 to 300 nm, and a styrene-based weight average molecular weight of the polymer measured by gel permeation chromatography (GPC) is in the range of 10000 to 200000.

18. The method for producing ink-jet-recorded matter on a fabric according to claim 13, wherein the ink composition contains a 1,2-alkylene glycol.

19. The method for producing ink-jet-recorded matter on a fabric according to claim 13, wherein the ink composition contains an acetylene-glycol-based surfactant and/or acetylene-alcohol-based surfactant.

20. The method for producing ink-jet-recorded matter on a fabric according to claim 13, wherein a content ratio of the polymer fine particle (mass %) is higher than a content ratio of the pigment (mass %).

21. Ink-jet-recorded matter on a fabric obtained by the method for producing ink-jet-recorded matter on a fabric according to claim 13.
